(19) United States
(12) Patent Application Publication
(10) Pub. No.: US 2026/0289854 A1
(43) Pub. Date: Sep. 24, 2026

(54) SYSTEM

(71) Applicant: SoftBank Group Corp., Tokyo (JP)

(72) Inventor: Koji ANTO, Tokyo (JP)

(73) Assignee: SoftBank Group Corp., Tokyo (JP)

(21) Appl. No.: 19/562,883

(22) Filed: Mar. 11, 2026

(30) Foreign Application Priority Data
Mar. 19, 2025 (JP) 2025-044969

(51) Int. Cl. G06T 11/60; G06N 3/0475

(52) U.S. Cl. CPC G06T 11/60; G06N 3/0475

(57) ABSTRACT

A system includes a processor that is configured to: electronically collect, by using an information processing device, information regarding characteristics, a manufacturing process, and a history of a target product and store the information in a database, generate a prompt for instructing a generative AI model to generate an appeal text and cause a natural language processing device to generate the appeal text by using the generative AI model, and generate a prompt for instructing a generative AI model to generate an image that expresses visual features of the target product and cause an image generation device to generate the image by using the generative AI model.

### CROSS-REFERENCE TO RELATED APPLICATION

This application is based on and claims priority under 35 USC 119 from Japanese Patent Application No. 2025-044969 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for creating promotional materials for products, particularly products whose value depends on storytelling, such as traditional crafts, local specialty goods, and culturally significant items, rely heavily on manual work by marketers, designers, or the product owners themselves. In typical workflows, information regarding a target product's characteristics, manufacturing process, and historical or cultural background is collected in an unstructured manner, for example through interviews, emails, or ad hoc documents. This information must then be manually analyzed and converted into persuasive appeal text and separate design briefs for visual materials. As a result, the quality, consistency, and depth of the resulting promotional materials depend greatly on the skills and experience of individual creators, and the process is time-consuming and costly.

Furthermore, even when generative AI models for natural language generation and image generation become available, there is no integrated mechanism that systematically collects product-specific information, generates appropriate prompts, and coordinates both text generation and image generation in a unified workflow. Users who are unfamiliar with prompt engineering or AI model operation may not be able to effectively utilize such models. Moreover, there is a lack of systems that store the collected product information in a structured database and automate the generation of coherent promotional materials that combine generated appeal text and images in a digital format suitable for actual marketing use.

Therefore, there is a need for a system that electronically collects and structures detailed information about a target product, automatically generates appeal text and images by using generative AI models based on that information, and efficiently creates and delivers integrated promotional materials, while allowing the user to review and modify the materials as needed.

### SUMMARY

To solve the above-described problems, a system according to one aspect of the present invention comprises a processor configured to perform a series of coordinated processing steps utilizing generative AI models for both text and image generation.

The processor is configured to electronically collect, by using an information processing device, information regarding characteristics, a manufacturing process, and a history of a target product and to store the collected information in a database in association with the target product. By structuring and storing such information, the system establishes a data foundation that can be reused and systematically referenced for generating promotional content.

The processor is further configured to generate a prompt for instructing a generative AI model to generate an appeal text that describes the target product based on the collected information, and to cause a natural language processing device to generate the appeal text by using the generative AI model. In this way, the system automatically produces persuasive promotional wording that reflects the specific characteristics, manufacturing process, and historical background of the target product, without requiring the user to directly design prompts or manually draft marketing copy.

In addition, the processor is configured to generate a prompt for instructing a generative AI model to generate an image that expresses visual features of the target product, and to cause an image generation device to generate the image by using the generative AI model. By doing so, the system automatically creates visual content that is consistent with the product's attributes and suitable for use in promotional materials, again without demanding specialized design skills or detailed prompt creation from the user.

According to one embodiment, the processor is configured to integrate the generated appeal text and the generated image and to create promotional material in a digital format. The integration may include combining the text and image into a layout such as an electronic flyer, web page, or other digital document that can be directly used for marketing purposes. This automatic composition step ensures coherence between the textual and visual elements and reduces the time and effort required for manual design work.

According to another embodiment, the processor is configured to transmit completed promotional material to a terminal of a user and to enable the user to review the promotional material and make modifications to the promotional material as needed. Through this functionality, the user can confirm the automatically generated content, adjust wording or images if desired, and finalize the promotional materials for distribution. As a result, the system provides an end-to-end solution from data collection to generation, integration, and user-assisted refinement of promotional materials, thereby addressing the problems of conventional manual workflows and limited accessibility to generative AI technologies.

The term “system” refers to an arrangement including at least one processor and one or more devices, components, or modules that are configured to cooperate to perform the functions described in the claims.

The term “processor” refers to any hardware component, such as a central processing unit (CPU), microprocessor, or dedicated processing circuitry, that executes instructions and controls operations of the system as described in the claims.

The term “information processing device” refers to any device, which may include a server, client terminal, or other computing apparatus, that is used to input, acquire, or transmit information regarding a target product to the processor of the system.

The term “target product” refers to any product or item for which promotional materials are to be created, including, but not limited to, traditional crafts, local specialty goods, manufactured articles, or services represented as products.

The term “characteristics” refers to attributes or features of the target product, including, for example, material, appearance, function, taste, texture, color, shape, or other descriptive properties.

The term “manufacturing process” refers to a series of operations, steps, or techniques used to produce the target product, including, for example, preparation of materials, processing, assembly, firing, aging, or finishing steps.

The term “history” refers to information regarding the background of the target product, including, for example, its origin, development over time, cultural or regional significance, and any related historical events or stories.

The term “database” refers to any structured data storage system, including relational databases, NoSQL databases, or other storage schemes, that is configured to store and manage information regarding the target product in an electronically retrievable form.

The term “generative AI model” refers to any machine learning model or artificial intelligence model configured to generate content, such as text or images, in response to input data or prompts.

The term “prompt” refers to data, typically in the form of text or structured parameters, that is supplied to a generative AI model in order to instruct the model to generate particular content, such as appeal text or images.

The term “natural language processing device” refers to any device, system, or service that is configured to execute a generative AI model for natural language processing so as to generate text, including appeal text, based on a prompt.

The term “appeal text” refers to promotional wording or descriptive text that is generated to appeal to potential customers by highlighting the characteristics, manufacturing process, history, or value of the target product.

The term “image generation device” refers to any device, system, or service that is configured to execute a generative AI model for image generation so as to generate an image based on a prompt.

The term “image” refers to digital visual content, including photographs, illustrations, or graphics, that expresses visual features of the target product.

The term “visual features” refers to aspects of the target product that can be visually perceived, including, for example, shape, color, pattern, surface texture, packaging, and surrounding scene or background.

The term “promotional material” refers to any digital content created for the purpose of advertising or marketing the target product, including, for example, electronic flyers, web pages, digital brochures, or other electronic documents that combine text and images.

The term “digital format” refers to a representation of data in an electronic form that can be stored, transmitted, displayed, or printed by electronic devices, including formats such as HTML, PDF, image files, or other digital document formats.

The term “terminal of a user” refers to any end-user device, such as a personal computer, smartphone, tablet, or similar equipment, that is used by a user to receive, display, review, and optionally modify the promotional material.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

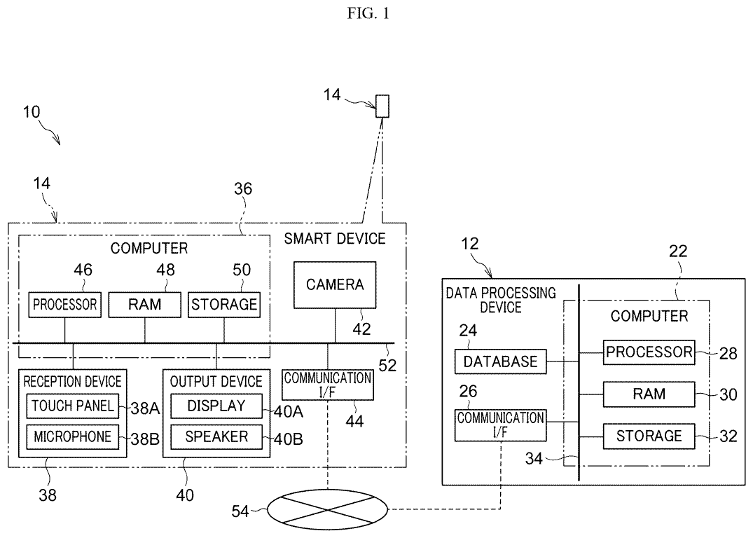

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein.

The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

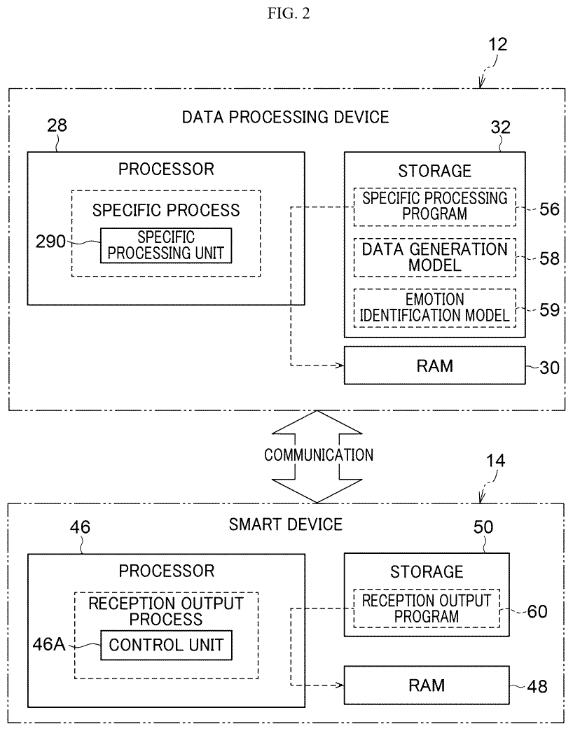

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-assisted content generation systems for marketing materials typically treat user-provided product information as unstructured free text and pass such text directly to generative models. In these systems, a processor generally forwards loosely formatted descriptions to a language model or an image model, receives generated text or images, and then leaves layout design and integration to manual editing or separate tools. As a result, several technical problems arise in the operation of the computing environment.

First, because the input information is not systematically structured, the generation of prompts for a generative AI model is ad hoc and inconsistent. The processor often cannot reliably associate particular product attributes, such as manufacturing process or historical background, with specific portions of a prompt. This leads to unstable model behavior and non-deterministic use of hardware resources, including unnecessary repeated calls to the generative AI model due to unsatisfactory outputs, thereby degrading computational efficiency and increasing network and processor load.

Second, known systems generally do not provide a unified data flow from user interaction through prompt construction to layout generation. User input is collected in one context, prompt sentences are crafted separately, and layout data is assembled in yet another step, often by different software components without a common structured representation. This fragmentation prevents the processor from reusing intermediate data structures, results in redundant parsing and transformation operations, and increases memory usage, communication overhead between modules, and latency in generating final promotional materials.

Third, when a user requests modifications to generated promotional materials, conventional systems typically require manual rewriting of text or manual editing of images and layout in desktop software. The processor does not systematically map user modification instructions back to the underlying prompt sentences or structured product data. Therefore, even minor changes often force a human operator to repeat large parts of the process, including manual design work. This lack of prompt-level feedback control prevents efficient incremental regeneration of only the necessary components and leads to increased computation time and inconsistent results across iterations.

Fourth, existing systems rarely integrate interactive question-and-answer style input at the level of the computing architecture in a way that produces machine-usable structured data. Question-and-answer interfaces may be provided at the user interface level, but the resulting data is still handled as loosely organized text. Consequently, the processor cannot deterministically exploit the interactive structure to drive automated generation of both textual and visual content. This causes underutilization of the computing resources devoted to natural language processing and image generation, and complicates the implementation of scalable server architectures for high-volume marketing content generation.

Accordingly, there is a need for a system and method that, in a computing environment, systematically collects product-related information as structured data through an interactive interface, programmatically generates prompt sentences for a generative AI model based on that structured data, and automatically integrates the generated text and images into promotional material data. Such a system should improve the operation of the processor, memory, and network resources by reducing redundant processing, enabling deterministic prompt construction, and supporting prompt-level regeneration in response to user modification requests, thereby improving overall computational efficiency and consistency in generating marketing materials.

The specific processing by the specific processing unit 290 of the data processing device 12 in Example 1 is realized by the following means.

The present invention provides a server comprising a processor and a storage device, the processor being configured to control an information processing apparatus to acquire, in an interactive question-and-answer format, attribute information, manufacturing process information, and history information regarding a target article, to convert user responses into structured data, and to store the structured data in the storage device; to read, from the storage device, the structured data together with predefined text-generation conditions, to programmatically populate a template of a generation instruction sentence with the structured data so as to generate a prompt sentence for instructing a generative AI model to generate appeal text, and to transmit the prompt sentence to a natural language processing apparatus so that the natural language processing apparatus generates appeal text data; to read, from the storage device, the structured data together with predefined image-generation conditions, to extract or transform descriptions indicative of visual features from the structured data and to programmatically populate a template of a generation instruction sentence with the descriptions so as to generate a prompt sentence for instructing a generative AI model to generate image data representing visual features of the target article, and to transmit the prompt sentence to an image generation apparatus so that the image generation apparatus generates the image data; to automatically place the appeal text data and the image data into layout template data so as to generate promotional material data in an electronic document format or a screen display format; and to output identification information and acquisition information of the promotional material data and to provide, in response to an acquisition request or a modification request from an external terminal, prompt-level regeneration of at least one of the appeal text data and the image data by updating and retransmitting corresponding prompt sentences to the generative AI model and automatically reconfiguring the promotional material data based on regenerated data. This enables the computing system to maintain a unified structured data flow from user interaction through prompt construction to layout generation, to reduce redundant parsing and transformation operations, to deterministically control calls to generative AI models via programmatically generated prompt sentences, and to efficiently perform incremental regeneration of textual and visual components in response to user feedback, thereby improving overall processing efficiency, resource utilization, and consistency of automatically generated promotional materials.

The term “information processing apparatus” refers to an electronic apparatus including at least one processor and a memory, configured to execute a user interface program, exchange data with a server via a communication network, and acquire input data from a user in response to display of one or more information input screens.

The term “target article” refers to a physical product or service item for which attribute information, manufacturing process information, and history information are acquired and for which promotional material is generated by the system.

The term “attribute information” refers to information indicating general characteristics of the target article, including at least one of a name, a category, a production region, a material, a usage, and a design characteristic.

The term “manufacturing process information” refers to information indicating at least one step or method used to produce the target article, including, for example, processing steps, applied techniques, and production conditions.

The term “history information” refers to information indicating temporal background of the target article, including at least one of origin, period of use, development history, cultural background, and historical events related to the article.

The term “interactive question-and-answer format” refers to a mode of user interaction in which an information processing apparatus sequentially presents questions regarding the target article and receives corresponding answer data from a user for each question.

The term “structured data” refers to data organized according to a predefined data model, including fields or attributes associated with the target article, such that each piece of attribute information, manufacturing process information, and history information is stored in a machine-readable and addressable format.

The term “storage device” refers to a hardware component or subsystem, such as a memory or a persistent storage unit, configured to store structured data, template data, generated prompt sentences, appeal text data, image data, and promotional material data.

The term “predefined text-generation conditions” refers to one or more parameters or rules previously stored in the storage device, which specify requirements for generation of appeal text, including at least one of target audience, tone, style, length, and language.

The term “predefined image-generation conditions” refers to one or more parameters or rules previously stored in the storage device, which specify requirements for generation of image data, including at least one of resolution, style, aspect ratio, and composition.

The term “template of a generation instruction sentence” refers to text data including one or more placeholders, which is used as a base pattern for constructing a prompt sentence for a generative AI model by inserting structured data or derived information into the placeholders.

The term “prompt sentence” refers to a text string generated by the processor, including at least one instruction and information regarding the target article, which is transmitted to a generative AI model to control generation of appeal text data or image data.

The term “generative AI model” refers to a computational model based on machine learning, configured to generate content such as natural language text or image data in response to a prompt sentence, and executable on a computing resource separate from or included in the server.

The term “natural language processing apparatus” refers to a hardware and software configuration, including at least one generative AI model for text, which receives a prompt sentence and outputs appeal text data in a natural language.

The term “image generation apparatus” refers to a hardware and software configuration, including at least one generative AI model for image generation, which receives an image-related prompt sentence and outputs image data representing visual features of the target article.

The term “appeal text data” refers to machine-readable text information generated by the natural language processing apparatus in response to a prompt sentence, the text information emphasizing characteristics and value of the target article for use in promotional material.

The term “visual features” refers to attributes of the target article that can be visually perceived, including at least one of color, shape, pattern, texture, surface finish, and typical display context.

The term “image data” refers to digital data representing a visual depiction of the target article, generated by the image generation apparatus based on an image-related prompt sentence.

The term “layout template data” refers to data defining a structural arrangement for placement of text and image elements in a document or screen, including at least positions, sizes, and styles for an appeal text region and an image region.

The term “promotional material data” refers to electronic data representing at least one page or screen of a marketing or advertising material for the target article, including both appeal text data and image data arranged according to layout template data.

The term “electronic document format” refers to a file format suitable for digital storage and distribution of documents, including at least one of a portable document format, a markup-based document format, or a word-processing document format.

The term “screen display format” refers to data structured for rendering on a display device, including at least one of markup-based content, image content, or a combination thereof, for presentation as a user interface or web page.

The term “external terminal” refers to an information processing apparatus separate from the server, such as a client device operated by a user, which communicates with the server via a communication network to transmit acquisition requests or modification requests and to receive promotional material data.

The term “identification information” refers to data used to uniquely distinguish promotional material data within the system, including at least one of an identifier, a version number, and a creation timestamp.

The term “acquisition information” refers to data enabling retrieval of promotional material data, including at least one of a storage location, a network resource locator, or access parameters.

The term “modification request” refers to a request transmitted from an external terminal to the server, including data indicating at least one desired change in content, tone, visual representation, or layout of promotional material data.

The term “prompt-level regeneration” refers to processing in which the server updates a prompt sentence based on a modification request, resubmits the updated prompt sentence to a generative AI model, obtains regenerated content, and replaces corresponding portions of existing promotional material data with the regenerated content.

The term “automatically reconfigure” refers to processing performed by the processor without user intervention, in which the processor updates the arrangement and composition of promotional material data based on newly generated appeal text data and/or image data, while maintaining or adjusting layout template data as needed.

In one embodiment, a server cooperates with at least one terminal operated by a user to generate promotional material data for a target article by controlling specialized software modules and hardware resources. The server comprises at least one processor, a memory, a non-transitory storage device, and a network interface. The terminal comprises a processor, a memory, a display device, an input device, and a network interface. The server and the terminal are connected via a communication network such as the Internet or a local area network.

The server executes a server-side application implemented on a general-purpose computing platform, for example a hardware configuration including a multi-core central processing unit and, optionally, one or more graphics processing units. The server runs an operating system such as a general-purpose server operating system and a web application framework such as a typical server-side framework. The server further executes a database management system such as a relational database or a document-oriented database, and communicates with external generative AI model services or locally hosted generative AI models via an application programming interface.

The terminal executes a client-side application, which may be implemented as a web browser application or as a dedicated native application on a mobile or desktop operating system. The terminal displays user interface screens that are generated by the server and transmitted through standard web protocols. The user operates the terminal to input information, to review generated promotional material data, and to issue modification requests.

The server stores, in the storage device, executable program modules including at least: a question-answer interface control module, a structured data construction module, a prompt generation module for text, a prompt generation module for images, a generative model interface module, a layout composition module, and a material management module. Each module is implemented as computer-executable instructions that, when executed by the processor of the server, cause the processor to perform specific data transformations and control of external computing resources.

The server uses the question-answer interface control module to cause the terminal to present questions related to attribute information, manufacturing process information, and history information regarding a target article. The server transmits definitions of questions, answer formats, and validation rules to the terminal. The terminal displays each question on the display device and receives user input via the input device. The terminal sends answer data to the server after local validation, for example length checks and type checks. The server receives the answer data via the network interface and writes the data to the memory.

The server uses the structured data construction module to convert the answer data into structured data that conforms to a predefined schema. The server defines a schema including fields such as “article_name,” “article_category,” “production_region,” “material,” “manufacturing_steps,” “historical_background,” “cultural_significance,” and “visual_descriptors.” The server parses the answer data, maps it to the corresponding fields, and generates a structured record. The server stores this structured record in the database with a unique identifier. In addition, the server may derive supplementary fields, such as “target_audience,” “tone,” and “language,” based on user selection or determinations made by a rule-based classifier.

The server uses the prompt generation module for text to construct a prompt sentence for a generative AI model that produces appeal text data. The server stores at least one template of a generation instruction sentence in the storage device. The template may include placeholders for inserting field values from the structured data. The server reads the template into the memory, accesses the structured data from the database, and programmatically replaces the placeholders with values such as article name, production region, material, manufacturing steps, and historical background. The server thereby generates a complete prompt sentence that conforms to a deterministic structure.

For example, the server may generate a prompt sentence such as:

“Using the following information about a traditional product, please generate an appeal text in Japanese for use in marketing materials.
Product name: traditional porcelain teacup
Production region: a production region in a specific prefecture
Material: white porcelain
Manufacturing process: hand-painting, glazing, high-temperature firing
History and cultural value: more than 400 years of history, exported overseas in the 17th century, representative of traditional porcelain craftsmanship
Visual features: glossy white surface with delicate blue floral patterns
Target audience: overseas customers unfamiliar with traditional crafts
Tone: professional but warm
Length: about 400 Japanese characters.”

The server uses the generative model interface module to transmit the generated prompt sentence to a natural language processing apparatus. In one embodiment, the natural language processing apparatus comprises a generative AI model for text, implemented as a transformer-based neural network. The transformer-based neural network includes an encoder-decoder structure or decoder-only structure with self-attention layers, feedforward layers, layer normalization modules, and learned token embeddings. The model is trained on a large corpus of natural language text using an autoregressive language modeling objective, where the error function is a cross-entropy loss between predicted token distributions and ground-truth tokens. During training, the model updates its weights via stochastic gradient descent or a variant such as Adam, with backpropagation applied through the network layers. The training data may be augmented by synthetic variations of sentences, paraphrases, or domain-specific examples.

During inference, the server sends the prompt sentence as an input sequence of tokens to the natural language processing apparatus via a remote or local API. The server specifies generation parameters such as temperature, top-k or top-p sampling thresholds, maximum token count, and stop conditions.

The model executes on dedicated hardware, such as a GPU cluster, and computes probability distributions over the vocabulary for each successive token. The model generates the appeal text data by selecting tokens according to the sampling strategy and concatenating them into a text string. The server receives the generated appeal text data as part of an API response and stores it in the database linked to the structured data record.

The server uses the prompt generation module for images to construct a prompt sentence for an image generation apparatus. The server stores an image prompt template with placeholders for visual descriptors, context, lighting, and style. The server reads the structured data and extracts terms describing visual features, such as color, pattern, surface finish, and typical usage scenes. The server may apply rule-based transformations to enrich or normalize the descriptions. For example, the server may convert “blue pattern on white base” into “a pure white porcelain teacup with fine blue hand-painted patterns.” The server inserts these transformed visual descriptors into the template, along with context such as “Japanese interior” and lighting conditions such as “soft natural daylight.”

For example, the server may generate an image prompt sentence such as:

“Create a high-resolution promotional image of a traditional porcelain teacup. The teacup is made of pure white porcelain with delicate blue hand-painted floral patterns and a glossy finish. Place the teacup on a natural wooden table in a calm interior space, with soft natural light coming from the side. Emphasize the refined craftsmanship, the subtle reflections on the porcelain surface, and the elegant, traditional atmosphere. Style: realistic, clean, suitable for use in marketing materials.”

The server transmits this prompt sentence to the image generation apparatus. In one embodiment, the image generation apparatus comprises a diffusion-based generative AI model. The diffusion model represents images in a high-dimensional latent space and is trained to iteratively denoise noisy latent representations into meaningful image representations. Training is performed using a noise schedule, where Gaussian noise is gradually added to training images and the model learns to predict and remove noise at each step. The loss function may be a mean squared error between the predicted noise and the true noise. The model includes a neural network architecture, such as a U-Net with convolutional layers, residual connections, and attention mechanisms. Conditioning on text is achieved by encoding the prompt sentence using a text encoder and injecting the resulting embeddings into the U-Net through cross-attention layers.

During inference, the server calls the diffusion model with the text embeddings of the image prompt sentence, a specified number of denoising steps, an image resolution, and a guidance scale parameter that controls the strength of the prompt conditioning. The diffusion model runs on GPU hardware and iteratively refines random noise into an image latent representation consistent with the prompt.

The model then decodes the latent representation into an image, for example in a bitmap format. The server receives the generated image data, verifies the format and resolution, and stores it in an object storage or in the database.

The server uses the layout composition module to combine the appeal text data and the image data into promotional material data. The server stores layout template data describing positions of text blocks, image regions, margins, fonts, and color schemes. The server reads the layout template data and fills the designated regions with the generated content. For example, the server may insert the article name into a title region, the appeal text data into a body text region, and the image data into a main visual region. The server uses a document rendering engine to convert the filled layout into an electronic document format, such as a portable document format, or into a screen display format, such as markup-based content suitable for web rendering. The server stores the resulting promotional material data and associates it with identification information and acquisition information.

The server uses the material management module to handle acquisition requests and modification requests from the terminal. When the terminal requests the promotional material data, the server retrieves the data and transmits it via the network interface. When the user views the promotional material data on the terminal and determines that modifications are needed, the user enters modification instructions, such as a request to change the tone, to add information about gift suitability, or to adjust the background of the image. The terminal sends these modification instructions to the server.

The server interprets the modification instructions and updates the corresponding prompt sentences.

For example, if the user requests a more casual tone, the server modifies the “tone” parameter in the text generation prompt template. If the user requests a different background, the server alters the context component of the image prompt sentence. The server then reissues the updated prompt sentences to the generative AI models via the generative model interface module. The server obtains regenerated appeal text data and/or regenerated image data and reinserts them into the layout template data. The server thus automatically reconfigures the promotional material data without requiring the user to manually edit text or images. This prompt-level regeneration reduces the amount of recomputation, because only the components affected by the modification are regenerated, and reuse of layout information avoids redundant layout calculations.

The server improves computer technology in several ways. By converting user answers into structured data and using programmatic prompt generation, the server reduces ambiguity and variance in input prompts, which stabilizes generative AI model behavior and decreases the number of iterations needed to obtain acceptable outputs. This directly reduces processor usage, network traffic to external model endpoints, and memory consumption for intermediate data. By using a unified structured representation from input collection through layout composition, the server avoids repeated parsing and text segmentation that would otherwise be required at multiple stages. This results in lower latency and more deterministic resource usage patterns.

The server further improves technical performance by coupling rule-based prompt construction with neural generative models. The rule-based component ensures that specific fields, such as manufacturing steps and historical background, are always present and placed in predetermined sections of the prompt sentence. This differs from human operators manually drafting prompts in a non-systematic manner. The fixed structure of prompts allows the generative AI models to be tuned and cached for anticipated prompt patterns, which can reduce inference time and variance. The server may, for example, cache tokenized versions of prompt templates or reuse precomputed text embeddings for invariant parts of the templates. These techniques reduce computational load on the text encoder or tokenizer components.

The server uses non-conventional processing steps to link user modification instructions to underlying prompts, instead of simply editing output text or images. The modification instructions alter the structured data fields or generation condition parameters, which in turn alter specific segments of the prompt sentences. This layered representation allows the server to perform fine-grained regeneration of only relevant output components. For example, if the user changes the target audience from “general consumers” to “luxury collectors,” the server updates only the corresponding field in the structured data and regenerates the appeal text, while reusing existing image data and layout information. This approach reduces overall computation time and network bandwidth compared to regenerating the entire promotional material from scratch.

The server uses a specific data flow and module configuration. The question-answer interface control module generates user interface specifications for the terminal. The structured data construction module ensures that each answer is normalized and stored in a consistent format. The prompt generation modules produce deterministic prompt sentences that map directly to structured data fields. The generative model interface module encapsulates communication with external or internal generative AI models, handling tokenization, batching, and error processing. The layout composition module uses layout templates to implement a clear separation between content and presentation. The material management module coordinates storage, retrieval, and regeneration operations. This modular architecture facilitates scaling across multiple servers, because each module can be replicated or distributed independently.

In another embodiment, the server may host the generative AI models locally. In this case, the server loads model weights into GPU memory and executes inference routines directly. The server may then apply optimized scheduling and batching of prompt sentences for multiple users, reducing per-request overhead. Local hosting also allows the server to apply custom fine-tuning procedures, where domain-specific training data is used to adjust model weights. For example, the server may fine-tune the language model on a corpus of technical descriptions of traditional manufacturing processes. During fine-tuning, the server computes gradients of the loss function with respect to the model weights and performs weight updates to minimize error. This yields more accurate and consistent appeal text for that domain, improving the technical quality of generated outputs.

In yet another embodiment, the server may adjust the inference parameters dynamically based on system load or quality metrics. For instance, when the system is under heavy load, the server may reduce the number of denoising steps in the diffusion model or use a smaller language model, thereby trading off some output richness for faster response time, while maintaining acceptable quality due to the structured and rich prompt sentences. Conversely, when higher quality is required, the server may increase the number of inference steps or employ larger models, relying on the precise prompt structure to focus computational effort on semantically important information.

The terminal contributes to the technical effect by performing client-side validation and incremental transmission of user input. By checking basic constraints before sending data, the terminal reduces the likelihood of malformed data reaching the server, which reduces error handling overhead and retransmission. The terminal may also cache intermediate answers locally to avoid repeated transmission in case of network interruptions, thereby stabilizing the data flow between the terminal and the server.

The user interacts with the system by providing domain knowledge and preferences, but the transformation of this input into structured data, deterministic prompt sentences, and integrated promotional material data is carried out by the server using specific algorithms and data structures.

The server does not simply automate existing human procedures; instead, the server applies a combination of structured data modeling, rule-based template filling, and neural generative modeling to achieve a level of consistency, computational efficiency, and scalability that cannot be achieved by manual processes. The causal relationship between these technical measures and the resulting improvements-such as reduced latency, lower computational load, and higher consistency of generated promotional materials-demonstrates that the system provides a concrete improvement in computer technology, particularly in the management and processing of data for generative AI-based content generation.

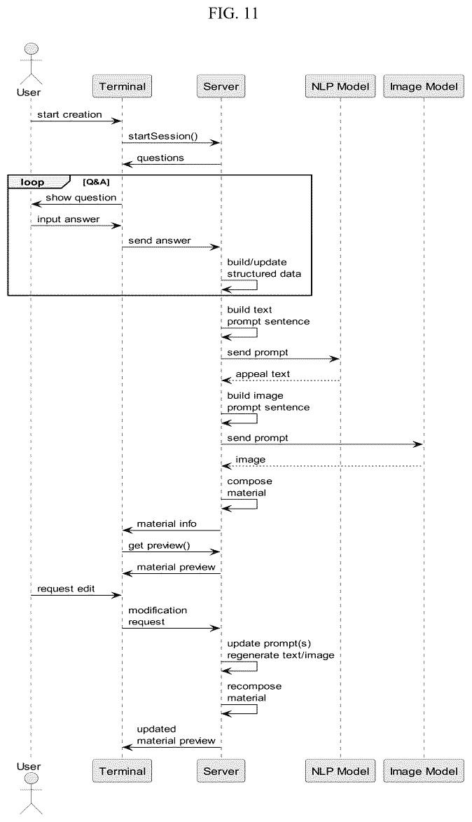

The following describes the processing flow using FIG. 11.

### Step 1

User operates the terminal to start a new promotional material creation session.

The input is a user command, such as tapping a “Create new material” button or selecting a target article category on the terminal.

The terminal displays an initial screen for target article selection and sends a session start request to the server.

The output is a session identifier and an initial question set received from the server.

### Step 2

Server generates and sends question definitions for interactive input.

The input is the session start request and, optionally, an article category or language preference from the terminal.

The server retrieves, from a configuration store, a list of questions and corresponding metadata (answer type, validation rules, field mapping) for attribute information, manufacturing process information, and history information.

The server creates a structured question list including identifiers (for example, Q1, Q2), question text, expected data type (string, list, numeric), and constraints (minimum length, required flag), and transmits this question list to the terminal.

The output is the structured question list transmitted to the terminal.

### Step 3

Terminal displays questions in a one-question-and-one-answer format and collects user input.

The input is the structured question list received from the server.

The terminal renders each question sequentially on the display, using native UI components or web form elements, and waits for user input.

User enters answers describing the target article, including name, production region, materials, manufacturing steps, history, cultural value, and visual features.

The terminal validates each answer locally (for example, checking that required answers are not empty and that text length is within bounds) and packages each answer with the corresponding question identifier.

The output is validated answer data for each question.

### Step 4

Terminal transmits answer data to the server.

The input is the set of validated answers associated with question identifiers.

The terminal aggregates the answers into a structured request message, for example a JSON object with key-value pairs (question_id: answer_text), and sends this message to the server via a communication protocol such as HTTPS.

The output is a data submission request carrying all user-provided article information.

### Step 5

Server constructs structured data for the target article.

The input is the answer data received from the terminal.

The server parses the request message, matches each question identifier to a predefined schema field (for example, mapping Q1 to “article_name” and Q2 to “production_region”), and normalizes the text (trimming whitespace, standardizing character encoding, optionally performing basic language detection).

The server populates a structured record with fields such as “article_name,” “article_category,” “production_region,” “material,” “manufacturing_steps,” “historical_background,” “cultural_significance,” and “visual_descriptors.”

The server performs data processing such as concatenating multiple answers into ordered lists, splitting long free-form descriptions into subfields, and generating derived fields like “target_audience,” “tone,” and “output_language” based on user selections or default rules.

The server stores this structured record in a database and assigns a unique article identifier.

The output is the structured data record associated with the article identifier.

### Step 6

Server generates a prompt sentence for the text generative AI model.

The input is the structured data record and predefined text-generation conditions (tone, length, target audience, language).

The server retrieves a text prompt template from storage, which includes placeholders for fields such as article name, production region, material, manufacturing steps, historical background, visual features, target audience, tone, and length.

The server programmatically replaces each placeholder with the corresponding field value in the structured data record, concatenates the template segments, and forms a complete prompt sentence.

The server may apply formatting operations such as adding line breaks, bullet-like markers, or explicit labels (“Product name: . . . ”, “Material: . . . ”) to stabilize the generative AI model's behavior.

For example, the server may generate a prompt sentence such as:

“Using the following information about a traditional product, please generate an appeal text in Japanese for use in marketing materials.
Product name: traditional porcelain teacup
Production region: a production region in a specific prefecture
Material: white porcelain
Manufacturing process: hand-painting, glazing, high-temperature firing
History and cultural value: more than 400 years of history, exported overseas in the 17th century, representative of traditional porcelain craftsmanship
Visual features: glossy white surface with delicate blue floral patterns
Target audience: overseas customers unfamiliar with traditional crafts
Tone: professional but warm
Length: about 400 Japanese characters.”

The output is the fully constructed text prompt sentence.

### Step 7

Server transmits the text prompt sentence to the natural language processing apparatus and receives appeal text data.

The input is the text prompt sentence generated in Step 6.

The server invokes an API of a natural language processing apparatus that hosts a transformer-based generative AI model, converts the prompt sentence into a request payload, and sets inference parameters such as temperature, maximum tokens, and stop sequences.

The generative AI model processes the prompt sentence by encoding tokens, applying self-attention and feedforward layers, and producing a sequence of output tokens representing the appeal text.

The server receives the response, extracts the generated appeal text string, and may perform post-processing such as trimming trailing incomplete sentences, removing extraneous boilerplate, and checking for prohibited terms based on predefined rules.

The server stores the resulting appeal text data in the database with a link to the article identifier.

The output is the stored appeal text data ready for later layout.

### Step 8

Server generates a prompt sentence for the image generative AI model.

The input is the structured data record and predefined image-generation conditions (resolution, style, aspect ratio, composition).

The server retrieves an image prompt template that includes placeholders for visual descriptors, context, lighting, and stylistic instructions.

The server extracts and refines visual descriptors from the structured data, such as “white porcelain,” “blue floral patterns,” “glossy surface,” and “traditional interior context,” by applying rule-based transformations and phrase normalization.

The server inserts the refined visual descriptors and conditions into the image prompt template to create a complete natural-language image prompt sentence.

For example, the server may generate an image prompt sentence such as:

“Create a high-resolution promotional image of a traditional porcelain teacup. The teacup is made of pure white porcelain with delicate blue hand-painted floral patterns and a glossy finish. Place the teacup on a natural wooden table in a calm interior space, with soft natural light coming from the side. Emphasize the refined craftsmanship, the subtle reflections on the porcelain surface, and the elegant, traditional atmosphere. Style: realistic, clean, suitable for use in marketing materials.”

The output is the fully constructed image prompt sentence.

### Step 9

Server transmits the image prompt sentence to the image generation apparatus and receives image data.

The input is the image prompt sentence generated in Step 8.

The server calls an API of an image generation apparatus that implements a diffusion-based generative AI model, converts the prompt sentence into a request, and specifies parameters such as number of denoising steps, guidance scale, and output resolution.

The diffusion model converts the prompt sentence to text embeddings, initializes a noise tensor, and iteratively denoises the tensor through a U-Net architecture to generate a latent image representation consistent with the prompt.

The server receives the resulting image data (for example, a bitmap or encoded image), verifies its integrity, and optionally resizes or re-encodes it to meet layout requirements.

The server stores the image data in an object store or image table, records its storage location, and associates it with the article identifier.

The output is the stored image data reference and metadata.

### Step 10

Server composes promotional material data using layout template data.

The input is the appeal text data, the image data reference, and layout template data retrieved from storage.

The server reads a layout template defining positions for title, body text, image, and optional metadata fields (such as article category or company logo) and loads it into memory.

The server inserts the article name as a title, places the appeal text data into a designated text area, and binds the image data to an image region defined in the template.

The server applies formatting rules, such as font selection, line spacing, color scheme, and margin sizes, and uses a rendering engine to produce an electronic document (for example, a PDF file) or markup content (for example, HTML and style definitions).

The server stores the resulting promotional material data and generates identification information (material ID, version number) and acquisition information (access URL, file path).

The output is the completed promotional material data stored and indexed by identification information.

### Step 11

Server provides access information for the promotional material data to the terminal.

The input is the material identification information and acquisition information generated in Step 10.

The server constructs a response message containing the material identifier, preview URL, and download URL and transmits this message to the terminal.

The server may also include a summary of the article name and a thumbnail of the image for quick preview.

The output is the access information delivered to the terminal.

### Step 12

Terminal displays the promotional material preview to the user.

The input is the access information received from the server, including preview and download URLs.

The terminal requests the preview content from the server, retrieves the rendered HTML or a low-resolution representation of the PDF or image, and displays the promotional material on the display device.

The user visually inspects the appeal text and image, using scrolling and zooming functions provided by the terminal.

The output is user-visible rendering of the promotional material and, implicitly, the user's decision to accept or modify the material.

### Step 13

User issues a modification request via the terminal.

The input is the displayed promotional material and the user's subjective assessment of its suitability.

The user specifies modification instructions, such as “make the tone more casual,” “add information about suitability as a gift,” or “change the background to an outdoor scene,” by entering text or selecting options in a modification interface on the terminal.

The terminal packages the modification instructions together with the material identifier and sends a modification request message to the server.

The output is the structured modification request transmitted to the server.

### Step 14

Server updates prompt sentences based on the modification request and regenerates content.

The input is the modification request containing the material identifier and modification conditions.

The server retrieves the corresponding structured data record, original prompt sentences, and previous generation parameters.

The server adjusts structured data fields and/or generation conditions according to the modification conditions (for example, changes the “tone” field, adds a “gift_use” attribute, or modifies the context term from “interior space” to “outdoor terrace”).

The server regenerates a text prompt sentence and/or image prompt sentence with updated fields and parameters, then transmits these updated prompt sentences to the respective generative AI models.

The server receives regenerated appeal text data and/or regenerated image data and overwrites or versions the existing content in the database.

The output is updated appeal text data and/or updated image data associated with the same article identifier.

### Step 15

Server reconfigures the promotional material data using regenerated content.

The input is the updated appeal text data and/or updated image data, along with existing layout template data and material identification information.

The server loads the current layout template, replaces the old text block with the new appeal text, and/or replaces the previous image binding with the new image reference, preserving layout positions and style settings.

The server re-renders the promotional material into the target format (PDF, HTML, image), updates the stored file or creates a new version, and refreshes the acquisition information if necessary.

The output is a revised promotional material data instance made available to the terminal for renewed preview and possible further iteration.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional techniques for presenting information about physical products in retail environments typically rely on static descriptions, manually curated multimedia content, or pre-authored marketing materials stored in local systems. These approaches suffer from several technical limitations when applied to modern, sensor-equipped terminals such as head-mounted displays and other portable display devices operating in real-time mixed-reality contexts.

First, conventional systems do not efficiently integrate real-time image recognition on terminal-acquired image data with dynamic content generation on remote computing resources. Image recognition, database retrieval, natural language generation, and image generation are often implemented as disparate components without a unified orchestration by a processor that manages prompt sentences to a generative AI model and an image generation device. As a result, such systems cannot reliably or promptly generate context-sensitive appeal sentences and images for arbitrary target articles that appear in a user's field of view, which leads to latency, inconsistent output quality, and high development complexity.

Second, traditional architectures are not optimized to exploit the capabilities of generative AI models and image generation devices as programmable computational resources. In many cases, generative models are merely used offline to pre-generate generic content. There is no structured mechanism in which a processor systematically constructs prompt sentences from product-specific attribute information, production information, and history information acquired via a communication network, and then uses such prompt sentences to drive generation of tailored output in response to real-time recognition of individual target articles. Consequently, the system fails to fully leverage the representational power of generative AI models in a way that adapts to the exact product instance observed by the user.

Third, existing systems do not provide an efficient computer-implemented framework for integrating dynamic, AI-generated text and images into a single, synchronized display payload suitable for low-latency rendering on portable display terminals. In particular, there is no unified processing pipeline in which the processor integrates generative text and images into structured display data and coordinates transmission to a portable display terminal so that a visual presentation device can overlay the generated content in real time on the real scene of the target article. This lack of integration causes wasted network bandwidth, redundant processing on the terminal, and increased processing latency, thereby degrading user experience and limiting scalability.

Fourth, known systems do not provide a robust, computer-implemented one-question-one-answer mechanism that is specifically tied to the context of a recognized target article and that utilizes generative AI models as dynamic question-answering engines. While question-and-answer services exist in isolation, they are not tightly coupled with image-based product identification and database-backed retrieval of product-specific information. As a consequence, existing systems struggle to generate accurate, concise, and contextually appropriate responses that are aligned with the precise product that the user is currently viewing through the portable display terminal.

Accordingly, there is a need for an improved computer-implemented system that (i) coordinates image recognition of real-world target articles, (ii) acquires relevant product information from remote storage devices via a communication network, (iii) generates structured prompt sentences to drive generative AI models and image generation devices, and (iv) constructs and delivers integrated display data to portable display terminals for real-time, context-sensitive presentation. Such a system would improve the overall functioning of the computer system by reducing the amount of manual content authoring, optimizing data flows between terminals, servers, and remote generative services, and enabling scalable, dynamic generation and presentation of multimedia content in mixed-reality environments.

The specific processing by the specific processing unit 290 of the data processing device 12 in Application Example 1 is realized by the following means.

The present invention provides a server comprising a processor configured to receive, from an imaging device that captures an image of a target article in a real space, image data via a portable display terminal, to apply or cooperate with image recognition processing to identify the target article and obtain identification information of the target article, to acquire, based on the identification information, attribute information, production information, and history information related to the target article from a storage device connected via a communication network, to generate a prompt sentence including the acquired information and to input the prompt sentence to a generative AI model so as to cause the generative AI model to generate an appeal sentence in a natural language that explains characteristics and history of the target article, to generate another prompt sentence including the acquired information and to input the other prompt sentence to an image generation device so as to cause the image generation device to generate an image representing visual features of the target article, to integrate the generated appeal sentence and the generated image into display data, and to transmit the display data to the portable display terminal so that a visual presentation device of the portable display terminal presents, in real time, the appeal sentence and the image in superposition with a real scene of the target article. This enables an improvement in computer functionality by providing a coordinated, server-centric processing pipeline that automates prompt sentence construction, orchestrates remote generative AI resources, and delivers integrated, context-aware multimedia content to a resource-constrained portable display terminal with reduced latency and reduced manual content creation effort, thereby enhancing scalability and responsiveness of real-time mixed-reality product information presentation.

The term “system” refers to an arrangement of one or more computing devices and associated components that cooperatively execute processing to perform the functions described in the claims.

The term “processor” refers to a hardware processing unit or combination of hardware processing units, such as a central processing unit or other programmable processing circuitry, configured to execute instructions and perform logical and arithmetic operations.

The term “imaging device” refers to an apparatus having an image sensor or equivalent component that captures image data representing a scene in a real space, such as a camera mounted on a portable display terminal.

The term “image data” refers to digital data representing one or more images or frames captured by the imaging device, including pixel values and any associated metadata.

The term “target article” refers to a physical object located in a real space, such as a product or merchandise item, for which information is to be identified and presented to a user.

The term “real space” refers to a physical environment in which the target article is actually present, as opposed to a simulated or purely virtual environment.

The term “image recognition processing” refers to processing that analyzes image data to detect, classify, or identify objects within the image data, including techniques such as object detection, feature extraction, and pattern recognition.

The term “identification information” refers to information that uniquely or specifically indicates a particular target article, such as an identifier, code, or index used to retrieve related data from a storage device.

The term “communication network” refers to a wired or wireless data communication infrastructure, such as the Internet, a local area network, or a mobile communication network, used for transmitting data between devices.

The term “storage device” refers to a hardware resource that stores data in a non-transitory manner, such as a database server, network-attached storage, or cloud-based storage system.

The term “attribute information” refers to descriptive data regarding characteristics of the target article, such as category, material, size, color, or functional features.

The term “production information” refers to data regarding manufacturing-related aspects of the target article, such as place of manufacture, production method, producer, or production period.

The term “history information” refers to data regarding historical aspects of the target article, such as origin, cultural background, historical use, or evolution over time.

The term “prompt sentence” refers to text data that includes one or more instructions, conditions, or contextual elements, and that is provided as input to a generative AI model or an image generation device to control generation of output content.

The term “generative AI model” refers to a machine learning model that, in response to input including a prompt sentence, generates output data such as natural-language text based on learned patterns.

The term “appeal sentence” refers to text generated in a natural language that describes the target article with an emphasis on characteristics, history, or other aspects intended to attract user interest or stimulate purchase motivation.

The term “image generation device” refers to a computing resource or service that, in response to input including a prompt sentence, generates image data representing visual content that corresponds to the input.

The term “image” refers to digital visual data generated by the image generation device or derived from other processing, representing visual features of the target article or related scenes.

The term “visual features” refers to aspects of the target article that can be perceived visually, such as shape, pattern, color, texture, or overall appearance.

The term “display data” refers to structured data that includes at least an appeal sentence and an image, and that is formatted so as to be rendered by a portable display terminal for visual presentation.

The term “portable display terminal” refers to a computing device that is portable by a user, includes a display or visual presentation device, and is capable of communicating with the server, such as a head-mounted display, smart glasses, or handheld terminal.

The term “visual presentation device” refers to a hardware component of the portable display terminal that outputs visual information to the user, such as a display panel, optical see-through display, or other image display mechanism.

The term “real scene” refers to a view of the physical environment, including the target article, as perceived through the portable display terminal, which may be captured by the imaging device or seen directly through an optical see-through element.

The term “superposition” refers to a presentation mode in which computer-generated content, such as an appeal sentence or image, is overlaid on or displayed in registration with the real scene viewed by the user.

The term “real time” refers to processing and presentation that occur with latency sufficiently low that the output content appears substantially contemporaneous with changes in the user's view of the target article.

The term “voice input” refers to audio data representing speech uttered by a user and captured by a microphone associated with the portable display terminal.

The term “operation input” refers to user interaction data obtained through one or more input mechanisms, such as touch input, button operation, gesture input, or other user interface actions on the portable display terminal.

The term “inquiry sentence” refers to text data representing a question or request for information from a user regarding a target article.

The term “response sentence” refers to text data generated by the generative AI model that constitutes an answer to an inquiry sentence.

The term “one-question-one-answer format” refers to a mode of interaction in which a single inquiry sentence from a user is responded to by a single, corresponding response sentence generated by the generative AI model.

In one embodiment, a server cooperates with a portable terminal and an imaging device to implement the claimed system.

### A. Overall Configuration

A server includes at least one processor, a main memory, a non-transitory storage, and a network interface. The server executes an operating system such as a general-purpose server operating system and runs one or more application programs that implement image-recognition cooperation, database access, prompt sentence construction, interaction with a generative AI model, interaction with an image generation device, integration of output data, and transmission of display data.

A terminal includes a processor, a memory, a wireless communication interface, an imaging device, a visual presentation device, an audio input device, and optionally an audio output device. In one example, the terminal is implemented as head-mounted smart glasses. The terminal runs an embedded operating system, such as a mobile operating system, and executes an application program that captures image data from the imaging device, sends data to the server, receives generated content from the server, and renders the content as an overlay on a real scene.

A user wears the terminal in a real environment where target articles are arranged, such as a commercial space. The user moves freely and directs the gaze toward different target articles. The imaging device continuously captures image data of the real scene that the user is facing.

### B. Hardware and Software Modules on the Terminal

The terminal uses a camera module as the imaging device. The terminal uses a camera driver exposed by the operating system to obtain image frames. The terminal stores the frames temporarily in memory and applies preliminary processing.

The terminal uses a computer vision library such as OpenCV or a similar library to perform basic image-processing operations. The terminal performs resizing, color conversion, and normalization to produce data suitable for input to a recognition model.

The terminal optionally uses an embedded deep neural network inference engine, such as an implementation based on a lightweight framework (for example, a mobile deep learning runtime), to detect instances of articles in the image data. The terminal uses a convolutional neural network with several convolutional layers, non-linear activation layers, pooling layers, and fully connected layers trained for object detection and classification. The terminal uses the output of the final layer, which produces bounding box coordinates and class probabilities, to determine which region corresponds to a likely target article.

The terminal uses a code-recognition module, for example a two-dimensional barcode decoding library, to detect and decode machine-readable codes, if present, on the article or in the vicinity. The terminal combines the classification output of the convolutional neural network and any decoded codes to determine identification information of the target article. The terminal uses a predefined mapping in a local table or a small cache to map detected patterns into target article identifiers.

The terminal uses a wireless communication module, such as Wi-Fi or cellular communication, to send the identification information to the server through a secure channel such as HTTPS. The terminal also uses the same communication path to send user inputs, including voice input and touch or button operations.

The terminal uses a rendering engine, such as one based on OpenGL ES or a similar graphics subsystem, to draw text and bitmap images on the visual presentation device. The terminal uses coordinate information derived from the image recognition result and, if available, pose estimation of the imaging device to place the overlays near or over the recognized target article so that a user perceives a consistent spatial alignment between the real article and the generated information.

The terminal uses a microphone and an audio driver to capture the voice of the user. The terminal either performs on-device speech recognition using a compact acoustic and language model or sends audio data to the server or a speech recognition service and obtains recognized text as an inquiry sentence. The terminal then forwards the inquiry sentence and the context information, such as the identifier of the currently viewed article, to the server.

### C. Hardware and Software Modules on the Server

The server uses a network interface and a communication library to receive messages from the terminal and to send responses to the terminal. The server uses an authentication and session management module to validate terminals and to associate successive requests with the same user session.

The server uses a database client library, such as a client library for a relational database or a client library for a key-value store, to access a storage device that stores information about target articles.

The storage device may be implemented as a cloud-based database service. The storage device stores attribute information, production information, and history information. This information may be stored in several tables, where each record includes a unique identifier that corresponds to the identification information received from the terminal. The server performs one or more queries, such as relational queries or document retrieval operations, to obtain the attribute, production, and history information.

The server uses a module that constructs prompt sentences. In this module, the server uses a string template or rule-based assembly logic. The server inserts attribute information, production information, and history information into predetermined slots of the template and thereby generates a prompt sentence that describes the target article and instructs the generative AI model how to produce an appeal sentence. The server also generates another prompt sentence directed to an image generation device, instructing it to produce a visual representation that emphasizes certain visual features.

The server uses a generative AI model interface module to send the constructed prompt sentence to a remote generative AI model. The generative AI model is implemented as a large-scale neural network, for example a transformer-based language model. The model includes multiple encoder and decoder blocks, each block containing self-attention layers, feed-forward layers, and normalization layers. The model is pre-trained on text data and optionally fine-tuned on domain-specific data. The model uses tokenization to convert the prompt sentence into a sequence of discrete tokens. The model then uses the transformer architecture to compute contextual representations of the tokens and to predict subsequent tokens. The model has parameters, including weight matrices associated with self-attention and feed-forward layers, that are adjusted during pre-training using gradient-based optimization and a loss function such as cross-entropy error between predicted and actual next tokens.

The server uses an API client to send the prompt sentence and control parameters to the generative AI model. The server sets parameters such as maximum token length, sampling temperature, and top-k or top-p sampling thresholds to control the diversity and determinism of the response. The generative AI model returns an output token sequence, which the server converts to text forming the appeal sentence.

The server uses a similar generative AI model interface or a dedicated image generation interface to call an image generation device. The image generation device uses a generative model, for example a diffusion-based model. The diffusion model gradually denoises a random noise image according to the guidance of a text encoder that encodes the prompt sentence. The server passes the textual prompt sentence, which may include explicit mentions of color, texture, background, and style, as an input. The image generation device uses attention mechanisms to align words in the prompt with spatial areas in the generated image. The image generation device uses a loss function such as a reconstruction error or a perceptual loss during its training, and uses stochastic differential equations or iterative denoising steps during inference. The server receives generated image data in a bitmap format.

The server then uses an integration module to combine the appeal sentence and the generated image.

The server places them into a common data structure that includes fields such as article identifier, text content, image data reference, and optional formatting parameters, for example, font size, display position hints, and layout priorities. The server stores the image data in an object storage or cache and records a reference. The server then creates display data that can be rendered by the terminal.

For question-answer interaction, the server uses a Q&A construction module. When the server receives an inquiry sentence from the terminal along with the identification information for the target article, the server queries the storage device again if necessary to retrieve any specific information relevant to the question, such as handling instructions or safety information. The server then constructs a prompt sentence that establishes a role (for example, that of a store assistant), includes the relevant product information, and appends the inquiry sentence. The server instructs the generative AI model to answer in a single sentence. The server sets constraints in the prompt, such as length and tone, and adjusts model parameters, such as a low temperature, to reduce randomness.

The server then receives the response sentence. Because the model uses a transformer architecture that exploits long-range dependencies and attention mechanisms, the resulting answer can consider both the inquiry sentence and the retrieved product information. The server may perform simple checks, such as counting sentence terminators, to enforce a one-question-one-answer format, and may truncate any excess sentences.

### D. Example Prompt Sentences

The server can generate the following example prompt sentence for the appeal sentence:

“Create a short marketing appeal sentence that highlights the history and characteristics of the following product.

Product: A traditional porcelain cup.

History: Produced in a particular region with a history of over 400 years.

Features: Blue-and-white contrast, fine hand-painted patterns, thin but durable porcelain.

Write in a style suitable for in-store display.”

The server can generate the following example prompt sentence for image generation:

“Generate a high-resolution image of a traditional porcelain cup with a beautiful blue-and-white contrast and fine hand-painted patterns, placed on a wooden table in soft natural light, emphasizing elegance and craftsmanship.”

For question-answer interaction, the server can generate the following example prompt sentence: “You are a sales assistant in a traditional pottery store.

Product: A porcelain cup.

Care instructions: Hand wash with mild detergent, avoid microwave use, avoid sudden temperature changes.

Customer question: ‘How should I care for this cup?’

Answer the customer in one concise sentence, in an easy-to-understand and friendly tone.”

### E. Learning of the Generative AI Model and Image Generation Device

The generative AI model is constructed as a multi-layer transformer network. The model uses sub-word or word-piece tokenization. The model is trained on large corpora of text using a language modeling objective. During training, the model receives sequences of tokens and attempts to predict the next token. The model computes a loss function based on the cross-entropy between the predicted probability distribution over tokens and the actual token. The model uses backpropagation and an optimization algorithm such as stochastic gradient descent with adaptive moment estimation to update the weights. The model may be fine-tuned on text data that includes descriptions of products, marketing texts, and question-answer pairs related to products, to improve its performance on appeal sentences and product-related question answering.

The image generation device uses a generative model, for example a diffusion model conditioned on text. The diffusion model starts from random noise and iteratively denoises it, guided by a text encoder that maps the prompt sentence to a latent representation. During training, the model is provided with pairs of images and text descriptions. The model learns to reconstruct the images from noisy versions while respecting the text conditioning. The training process uses a loss function that measures the difference between generated images and ground truth images, possibly including perceptual losses computed on features of a pre-trained network. The image generation device uses a scheduler to control the denoising steps and may use classifier-free guidance to adjust the strength of the conditioning on the prompt sentence.

### F. Technical Effect and Computer-Technology Improvement

The server cooperates with the terminal to improve the functioning of the overall computer system in multiple ways. The server offloads heavy generative computations from the terminal. By centralizing prompt sentence construction, generative model invocation, and integration logic on the server, the system reduces the computation burden on the terminal, which is resource-constrained. This reduces energy consumption and allows the terminal to operate longer on battery power.

The server uses identification information to perform targeted retrieval of only the necessary product records, which reduces the volume of data transferred over the communication network. The server constructs compact display data that combines the appeal sentence and image reference in a single payload. This reduces the number of round trips and reduces communication overhead. As a result, the system achieves lower latency between user movement and content update, which is a technical improvement over architectures where the terminal independently downloads static content or where the user must manually search and load information.

The use of the generative AI model and the image generation device is not limited to automating human writing or design tasks. The server uses these models within a specific control framework: prompt sentences are automatically assembled from machine-readable article information, taking into account the real-time context of the user view. This assembly uses a rule-based approach that enforces structure and constraints on the output. The generative AI model executes complex high-dimensional vector computations that are infeasible for a human to reproduce in real time and that use attention-based mechanisms to integrate information from multiple fields. This allows the system to adapt the length, tone, and content of the appeal sentence to the context and to generate new variants without manual authoring, which is a machine-centric optimization that improves responsiveness and flexibility of the computing system.

The server uses specific data structures to manage content. For example, the server maintains a mapping from article identifier to a record that includes fields for attribute, production, and history information, and fields for generated content. The server stores prompt sentences themselves in logs to analyze which templates yield better performance in terms of latency and quality. The server may adapt prompt templates and model parameters based on this analysis, which improves future operation.

The terminal uses results from the server in a way that directly controls hardware, namely the visual presentation device and optional audio output device. The terminal renders text and images in alignment with the real spatial coordinates of the target article, using pose estimation and camera intrinsics. This involves computing transformation matrices and performing coordinate mapping, which are purely technical operations. The server's decision to provide data formatted as display data containing layout hints reduces the computation the terminal needs to perform to lay out elements, which results in reduced rendering overhead and smoother frame rates.

Because the system relies on consistent identification information and synchronized processing between terminal and server, the system can maintain high accuracy in which generated content is associated with which real-world article. This reduces error rates such as mis-association of descriptions with the wrong article, which is a technical improvement in information alignment in augmented reality environments.

### G. Alternative Embodiments and Variations

In one variation, the terminal performs more of the recognition work. The terminal can run a full object-recognition pipeline locally, only sending the identification information to the server. In another variation, the terminal transmits raw or compressed image data, and the server performs part or all of the image recognition using a more powerful neural network, such as a deep convolutional network with residual connections or a transformer-based vision model. The choice can be dynamically adjusted based on network conditions, terminal load, or desired accuracy. This dynamic allocation of computation contributes to technical improvement because it optimizes resource usage and maintains responsiveness under varying conditions.

In one embodiment, the server uses different generative AI models for different purposes. A smaller, faster language model may generate short labels for display, while a larger model may generate more detailed explanations when network conditions permit. The server selects the model according to device capabilities and network load, which reduces unnecessary processing and bandwidth usage.

In another embodiment, the server caches previously generated appeal sentences and images for popular articles. When the server receives an identification information corresponding to a cached article, the server can immediately send the cached display data without calling the generative models again. This decreases latency and reduces load on the generative services, which is a technical optimization of the overall system.

In yet another embodiment, the server performs additional processing on the generated image, such as resizing, cropping, or format conversion to match the resolution and color space of the terminal display. The server may also encode the image using a hardware-accelerated codec. Performing these computations on the server side reduces the processing requirement on the terminal and improves playback smoothness.

In a further embodiment, the system supports multiple types of terminals, including head-mounted displays, handheld terminals, and in-store fixed displays. The server includes device-profile data that describes the capabilities of each type of terminal, such as display resolution, field of view, and input modalities. The server uses this profile data in constructing display data, for example selecting shorter appeal sentences for smaller displays or adjusting aspect ratios for images. This device-aware adaptation represents a technical improvement in how content is generated and distributed, as it makes the computer system more robust and efficient across heterogeneous hardware.

Through these embodiments and variations, the server, terminal, and user cooperate in a technical system that uses generative AI models and prompt sentences as controlled computational tools integrated with image recognition, database access, and real-time mixed-reality presentation. The system thereby provides specific improvements in processing speed, accuracy of association between real-world objects and generated content, rendering efficiency, and communication efficiency, beyond mere automation of human tasks.

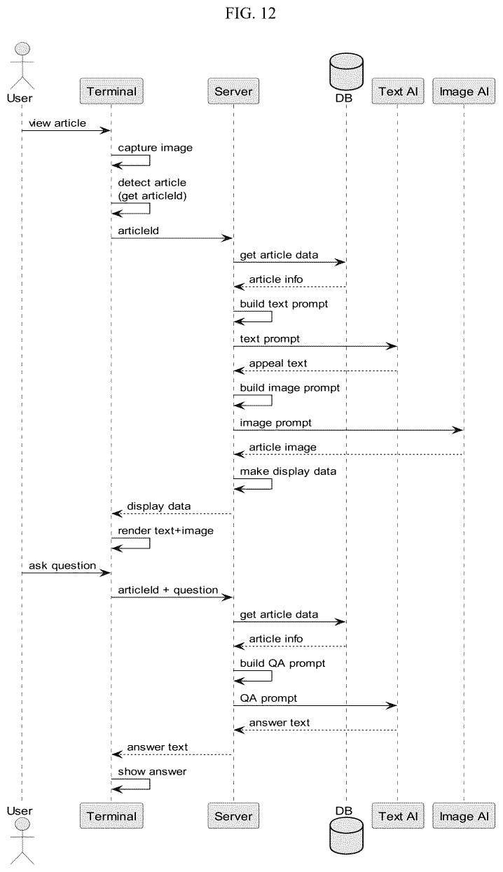

The following describes the processing flow using FIG. 12.

### Step 1

User wears the terminal and views a target article in a real space.

User positions the head such that the target article is within the field of view of the imaging device of the terminal.

Input: physical scene including the target article.

Output: optical signal incident on the imaging device of the terminal.

### Step 2

Terminal acquires image data from the imaging device.

Terminal uses a camera driver and operating system API to capture one or more image frames from the imaging device at a defined frame rate.

Terminal writes the raw pixel data into a frame buffer in memory.

Input: optical signal received by the image sensor.

Data processing: the imaging device converts the optical signal into electrical signals, and the terminal converts the electrical signals into digital pixel values arranged in a two-dimensional array (image data).

Output: digital image data representing the real scene including the target article.

### Step 3

Terminal performs pre-processing on the image data.

Terminal uses a computer vision library to resize the image to a fixed resolution, convert the color space (for example, from a device-specific format to RGB), and normalize pixel values to a specified numeric range suitable for neural network input.

Input: raw image data captured in Step 2.

Data processing: the terminal applies interpolation for resizing, matrix operations for color conversion, and linear transformations for normalization.

Output: pre-processed image data formatted as a tensor or array suitable for further recognition processing.

### Step 4

Terminal detects a candidate target article in the image data.

Terminal applies an object detection model, such as a convolutional neural network deployed with a lightweight inference engine, to the pre-processed image data.

Terminal computes feature maps through convolutional layers, activation functions, and pooling layers, and then obtains bounding box coordinates and class probabilities from the final layers.

Input: pre-processed image data from Step 3.

Data processing: the terminal performs iterative convolution, non-linear activation, and pooling operations to extract features and then applies fully connected or detection-specific layers to estimate object locations and classes.

Output: one or more bounding boxes with associated class scores indicating possible target articles.

### Step 5

Terminal selects a specific bounding box as the target article region.

Terminal uses a selection rule, such as choosing the bounding box closest to the center of the image or with the highest class probability, to determine which detected object is the current target article.

Input: list of bounding boxes and class probabilities from Step 4.

Data processing: the terminal evaluates each bounding box according to the selection rule, for example computing distances to the image center or comparing probability scores.

Output: coordinates of a selected bounding box that defines the region of the target article.

### Step 6

Terminal decodes machine-readable codes and determines identification information.

Terminal crops the region corresponding to the selected bounding box from the original image and applies a code recognition library to detect and decode any barcodes or two-dimensional codes.

Terminal combines decoded code values and the class label from the detection model to determine identification information for the target article, using a local mapping table if necessary.

Input: selected bounding box coordinates from Step 5 and original image data from Step 2.

Data processing: the terminal performs image cropping, pattern detection for codes, error-correction decoding, and table lookup or rule-based mapping.

Output: identification information for the target article, such as a product identifier string.

### Step 7

Terminal transmits identification information and context to the server.

Terminal constructs a request message that includes the identification information, a timestamp, terminal identifier, and optional camera pose information, and sends this message to the server via a secure network protocol.

Input: identification information from Step 6 and terminal context data.

Data processing: the terminal serializes the data into a structured format, for example a JSON document, and passes it to a network stack that segments and encodes the data for transmission.

Output: network packet(s) carrying the identification information and context to the server.

### Step 8

Server receives and parses the request from the terminal.

Server uses a network interface to accept the incoming request, verifies authentication data, and parses the structured payload to extract the identification information and associated metadata.

Input: network packet(s) transmitted from the terminal in Step 7.

Data processing: the server performs protocol decoding, message reassembly, decryption if necessary, and JSON or equivalent parsing to obtain logical fields.

Output: in-memory representation of the identification information and context for the target article.

### Step 9

Server retrieves product-related information from a storage device.

Server uses a database client library to issue a query based on the identification information, accessing a storage device that contains attribute information, production information, and history information for the target article.

Input: identification information from Step 8.

Data processing: the server constructs a query, such as a parameterized SQL statement or key-based lookup, transmits the query to the storage device, and receives a structured result set. The server then maps the result set into an internal data structure, for example a record or object with named fields.

Output: product-related information for the target article, including attribute information, production information, and history information.

### Step 10

Server constructs a prompt sentence for generating an appeal sentence.

Server uses a template or rule-based text assembly process to embed the attribute information, production information, and history information into a natural-language instruction directed to a generative AI model.

Input: product-related information from Step 9.

Data processing: the server inserts the retrieved fields into placeholders in a predefined template, concatenates strings in a defined order, and ensures that the resulting text satisfies length and format constraints.

Output: a prompt sentence designed to instruct the generative AI model to generate an appeal sentence.

### Step 11

Server calls the generative AI model to generate an appeal sentence.

Server sends the prompt sentence and control parameters such as maximum length and temperature to the generative AI model through an application programming interface.

Input: prompt sentence from Step 10 and control parameters.

Data processing: the generative AI model tokenizes the prompt, computes contextual embeddings via multiple transformer layers, and predicts a sequence of output tokens; the server receives the tokens, converts them back to characters and words, and combines them into a text string.

Output: a natural-language appeal sentence that describes characteristics and history of the target article.

### Step 12

Server constructs a prompt sentence for generating an image.

Server uses product-related information, and optionally the generated appeal sentence, to create a second prompt sentence that specifies visual features, desired style, and scene composition for an image generation device.

Input: product-related information from Step 9 and the appeal sentence from Step 11.

Data processing: the server evaluates which attributes are visually relevant, assembles descriptive phrases, and concatenates them into a coherent instruction that guides image creation.

Output: a prompt sentence directed to the image generation device for generating an image.

### Step 13

Server calls the image generation device to generate an image.

Server sends the image-oriented prompt sentence and parameters such as desired resolution and aspect ratio to the image generation device, which executes a generative algorithm such as a diffusion process to synthesize an image.

Input: prompt sentence from Step 12 and image generation parameters.

Data processing: the image generation device encodes the text prompt, iteratively refines a noisy image using learned denoising steps, and produces pixel data; the server receives the generated pixel data and stores it in an image file or buffer.

Output: digital image data representing visual features of the target article.

### Step 14

Server integrates the appeal sentence and the generated image into display data.

Server creates a display data structure that includes the appeal sentence, a reference or payload for the image, and any layout or formatting hints needed by the terminal.

Input: appeal sentence from Step 11 and image data from Step 13.

Data processing: the server assigns identifiers, associates text and image fields in a cohesive record, and optionally compresses or encodes the image for efficient transmission.

Output: display data containing both textual and visual content for the target article.

### Step 15

Server transmits display data to the terminal.

Server packages the display data into a response message and sends it to the terminal via the established network connection.

Input: display data from Step 14.

Data processing: the server serializes the display data, sets appropriate headers, and passes the data to the network stack for segmentation and transport.

Output: network packet(s) carrying the display data to the terminal.

### Step 16

Terminal receives and parses the display data.

Terminal uses its network interface to accept the response, checks status codes, and parses the structured format to extract the appeal sentence, the image content or reference, and layout parameters.

Input: network packet(s) with display data from Step 15.

Data processing: the terminal performs protocol decoding, reassembly, and deserialization of the display data fields.

Output: in-memory representation of the appeal sentence, image data, and layout hints.

### Step 17

Terminal prepares visual content for rendering.

Terminal decodes the received image data into a bitmap or texture compatible with the graphics subsystem and loads the appeal sentence into text rendering buffers.

Input: parsed appeal sentence and image data from Step 16.

Data processing: the terminal uses an image decoder to convert compressed image formats to raw pixels and uses font rendering or text layout utilities to calculate glyph positions and sizes.

Output: graphics-ready resources, including textures and text layout information, for the appeal sentence and image.

### Step 18

Terminal overlays the visual content on the real scene.

Terminal uses the graphics subsystem to render the decoded image and drawn text on the visual presentation device, positioning them according to layout hints and, if available, camera pose information to align with the target article in the user's field of view.

Input: graphics-ready resources from Step 17 and positioning information derived from Steps 4 and 5.

Data processing: the terminal computes transformation matrices, sets up rendering layers, and draws the overlays in synchronization with real-time camera frames or optical see-through display output.

Output: combined visual output in which the appeal sentence and image are superposed on the real scene as perceived by the user.

### Step 19

User views the augmented display and optionally issues a question.

User reads the appeal sentence and observes the generated image overlaid on the target article and may speak a question or perform an operation input on the terminal.

Input: visual information presented by the terminal.

Data processing: not executed by the system; the user cognitively interprets the presented information and decides whether to request additional details.

Output: user behavior, such as spoken inquiry or operation input, directed to the terminal.

### Step 20

Terminal acquires user inquiry and sends it to the server.

Terminal records audio via a microphone or detects a user operation such as a button press, converts the audio to text using a speech recognition module or maps the operation to a predefined inquiry, and constructs an inquiry sentence associated with the current target article identifier.

Input: user voice signal or operation input from Step 19 and current article identifier from Step 6.

Data processing: the terminal performs audio sampling, feature extraction, and recognition to obtain text, then combines the inquiry sentence and the article identifier into a structured message.

Output: request message containing the inquiry sentence and article identifier transmitted to the server.

### Step 21

Server constructs a prompt sentence for question answering and calls the generative AI model.

Server receives the inquiry message, retrieves or reuses the product-related information, and constructs a prompt sentence that includes a role specification, the product-related information, and the inquiry sentence, with explicit instructions to respond in a single sentence.

Input: inquiry sentence and article identifier from Step 20, and product-related information from Step 9 or a cache.

Data processing: the server assembles strings in a structured order, ensuring that context and constraints are included, and then sends the prompt sentence plus control parameters to the generative AI model, which processes the prompt via tokenization and transformer-based inference to generate a response sentence.

Output: a response sentence in a one-question-one-answer format generated by the generative AI model.

### Step 22

Server returns the response sentence to the terminal.

Server places the response sentence into a structured response message and transmits it back to the terminal.

Input: response sentence from Step 21.

Data processing: the server serializes the response sentence and uses the network interface to deliver the data to the terminal.

Output: network packet(s) carrying the response sentence to the terminal.

### Step 23

Terminal presents the response sentence to the user.

Terminal receives the response, extracts the response sentence, and displays it as additional text near the previously displayed appeal sentence and image, or optionally converts it to speech using a text-to-speech module.

Input: network packet(s) containing the response sentence from Step 22.

Data processing: the terminal deserializes the message, prepares text for rendering, and draws it on the visual presentation device or synthesizes audio output.

Output: visual or auditory presentation of the response sentence, enabling the user to receive a concise answer to the inquiry about the target article.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented workflows for generating marketing materials rely on loosely structured text input and manual authoring by human operators. In typical systems, a user enters free-form descriptions of a product, and a processing device merely forwards this unstructured text to a generative artificial intelligence model. As a result, the processing device has limited control over how product-related information is captured, organized, and translated into prompt sentences for generative models. This lack of structured interaction and internal data modeling constrains the ability of the computing system to consistently produce high-quality, product-specific marketing content.

In particular, in conventional systems, input collection is not optimized at the user-interface level or the data-model level. Free-form input often leads to incomplete or noisy product information, which reduces the effectiveness of downstream generative models. The computing resources used for generation are thus frequently applied to suboptimal prompts, causing wasted processing cycles, increased latency due to repeated trial-and-error prompting, and inconsistent outputs that require substantial manual editing. This degrades the overall efficiency of the computing environment and fails to leverage the full potential of automated generation.

Furthermore, prior systems typically treat text generation and image generation as independent black-box calls to separate generative models. There is no coordinated mechanism in the processing device to manage structured product profiles, to algorithmically construct and adjust prompt sentences for both natural language generation and image generation, and to integrate the respective outputs into a coherent, machine-generated digital document. The absence of an integrated control flow across collection, prompt construction, generation, and layout leads to fragmented processing, redundant user operations, and non-deterministic quality of the final materials.

Additionally, existing computer systems provide limited support for iterative refinement based on user feedback. When a user desires to emphasize different aspects of a product, change the expression style, or alter the visual representation, the user must manually craft new prompts and re-run generation in an ad hoc manner. The processing device does not maintain an internal, structured “information profile” that systematically incorporates user feedback into updated prompt sentences.

This results in inefficient reuse of previously collected data, unnecessary repetition of information entry, and higher computational load due to non-optimized prompt regeneration.

Accordingly, there is a need for an improved computer-implemented system and server-side processing architecture that (i) acquires product-related information through a structured one-question-and-one-answer interaction, (ii) maintains that information as structured data in a storage device, (iii) automatically composes and refines prompt sentences for multiple generative AI models based on the structured data and user feedback, and (iv) programmatically integrates generated text and images into digital marketing materials. Such a system should improve utilization of computing resources, reduce user burden, and enhance the consistency, controllability, and throughput of generative processing in a networked computing environment.

The specific processing by the specific processing unit 290 of the data processing device 12 in Example 2 is realized by the following means.

The present invention provides a server comprising a processor and a storage device, the processor being configured to acquire, via a communication network, attribute information, production environment information, provider background information, and usage pattern information regarding a target article from a user terminal in a sequential one-question-and-one-answer format; to store the acquired information as structured data in a storage area of the storage device together with question identification information and order information; to reconstruct, based on the order information, the structured data as an information profile for the target article; to generate a first prompt sentence as a character string by inserting the structured data of the information profile into a predetermined text-generation template, the first prompt sentence instructing generation of appeal text that emphasizes characteristics and background of the target article; to control input of the first prompt sentence to a generative artificial intelligence model for natural language generation so as to cause the generative artificial intelligence model to generate and output text data including the appeal text; to generate a second prompt sentence as a character string by using at least one of the structured data of the information profile and the generated text data, the second prompt sentence instructing generation of image data that visually represents the target article and an environment related to the target article; to control input of the second prompt sentence to a generative artificial intelligence model for image generation so as to cause the generative artificial intelligence model to generate and output image data including an image; to integrate the text data and the image data based on layout information to automatically generate marketing material data in at least one of an electronic document format and an image format; to provide the marketing material data to the user terminal in a downloadable format; and, after generation of the marketing material data, to receive from the user terminal at least one of emphasis-change information, expression-style-change information, and visual-expression-change information, to add the received information to the information profile, and to modify at least one of the text-generation template and the second prompt sentence based on the added information so as to regenerate the text data and the image data using the generative artificial intelligence models. This enables an improved computer-implemented generation pipeline in which the server-side processor systematically structures user input, algorithmically constructs and updates prompt sentences, and centrally orchestrates multiple generative AI models, thereby enhancing computational efficiency, controllability of generated content, and overall performance of the marketing material generation process.

The term “system” refers to a combination of hardware and software components that cooperatively execute processing steps to acquire information, control generative artificial intelligence models, and generate marketing material data.

The term “processor” refers to one or more hardware processing units, such as a central processing unit or a graphics processing unit, configured to execute instructions that implement the functions described herein.

The term “storage device” refers to any non-transitory computer-readable medium, such as a magnetic disk, optical disk, or semiconductor memory, capable of storing data and instructions for access by the processor.

The term “storage area” refers to a logical region within the storage device that is allocated for storing structured data, profiles, and generated content related to a target article.

The term “communication network” refers to any wired or wireless network, including local area networks and wide area networks, that enables data communication between the server and one or more user terminals.

The term “user terminal” refers to an information processing apparatus operated by a user, such as a personal computer, smartphone, or tablet, that transmits input information to the server and receives generated materials from the server.

The term “target article” refers to any item or service that is the subject of marketing or promotional activities and for which descriptive information and promotional materials are generated.

The term “attribute information” refers to information describing inherent properties of the target article, such as type, features, quality, or appearance.

The term “production environment information” refers to information describing a context in which the target article is produced or provided, including location, conditions, or processes associated with production.

The term “provider background information” refers to information describing a person, organization, or entity associated with producing or providing the target article, including history, philosophy, or intentions.

The term “usage pattern information” refers to information describing recommended or typical ways in which the target article is used, consumed, or enjoyed.

The term “one-question-and-one-answer format” refers to an interaction pattern in which a user is presented with a single question at a time and provides a single corresponding answer before a next question is presented.

The term “structured data” refers to data that is organized according to a predetermined schema, including fields, identifiers, and order information, enabling systematic processing by the processor.

The term “question identification information” refers to data that uniquely identifies a question presented in the one-question-and-one-answer format, enabling association between a question and a corresponding answer.

The term “order information” refers to data indicating a sequence of questions or answers, enabling reconstruction of the order in which information related to a target article was acquired.

The term “information profile” refers to a structured aggregation of attribute information, production environment information, provider background information, usage pattern information, and associated identifiers for a single target article.

The term “text-generation template” refers to a predefined pattern of text including placeholders into which structured data from the information profile is inserted to construct a prompt sentence for natural language generation.

The term “prompt sentence” refers to a character string that includes instructions and contextual information for a generative artificial intelligence model, thereby directing the model to generate specific text or image output.

The term “generative artificial intelligence model” refers to a machine-learned model configured to generate new data, such as text or images, based on an input prompt sentence.

The term “generative artificial intelligence model for natural language generation” refers to a generative artificial intelligence model that receives a text-based prompt sentence and outputs text data in a natural language.

The term “generative artificial intelligence model for image generation” refers to a generative artificial intelligence model that receives a text-based prompt sentence and outputs image data representing visual content.

The term “appeal text” refers to text data generated to promote or highlight characteristics, background, and value of the target article in a persuasive or descriptive manner.

The term “text data” refers to digital data representing one or more characters, words, or sentences, including generated appeal text and related natural language output.

The term “image data” refers to digital data representing a visual image, including pixel data encoded in formats such as bitmap or vector formats.

The term “image-generation prompt sentence” refers to a prompt sentence that describes visual elements and context of the target article and is used as input to a generative artificial intelligence model for image generation.

The term “layout information” refers to information defining an arrangement of text data and image data within a document or page, including positions, sizes, fonts, and formatting rules.

The term “marketing material data” refers to digital data representing one or more documents or images that integrate appeal text and images for use in promoting the target article.

The term “electronic document format” refers to a file format representing a multi-element digital document, including text and images, such as a portable document format.

The term “image format” refers to a file format used to encode image data, such as a raster or vector image file format.

The term “downloadable format” refers to a data format and transmission condition that allow a user terminal to retrieve and locally store a file via a communication network.

The term “emphasis-change information” refers to information indicating a change in priority or focus of aspects of the target article to be highlighted in regenerated text data or image data.

The term “expression-style-change information” refers to information indicating a modification of linguistic style, tone, or register to be applied when regenerating text data.

The term “visual-expression-change information” refers to information indicating a modification of visual style, composition, or motif to be applied when regenerating image data.

The term “regeneration” refers to processing in which at least one generative artificial intelligence model is invoked again using modified prompt sentences so as to newly generate text data or image data.

In one embodiment, a server executes a marketing material generation application on server hardware that includes at least one central processing unit (CPU), at least one graphics processing unit (GPU), a main memory, a non-transitory storage device, and a network interface. The server runs an operating system such as a UNIX-like operating system or a general-purpose server operating system. The server uses a web server module, such as software of the type of an HTTP server, and an application framework, such as software of the type of a server-side scripting framework, to communicate with at least one terminal operated by a user via a communication network.

The terminal includes a processor, a memory, a display, an input interface such as a touchscreen or keyboard, and a network interface. The terminal runs a web browser that executes client-side scripts written in a scripting language such as JavaScript. The user operates the terminal to access a web application provided by the server.

The server provides, to the terminal, a user interface that guides the user through a one-question-and-one-answer interaction. The server stores a question set in the storage device as structured data, for example in a relational database such as a database management system of the type of a SQL database. The question set includes fields for attribute information, production environment information, provider background information, and usage pattern information of a target article. The server transmits, to the terminal, one question at a time, including, as examples, “What is the name of the product?”, “Where is the product produced?”, “Please describe the main characteristics of the product (taste, appearance, etc.).”, “Please describe the background and passion of the producer.”, and “How is the product typically used or recommended?”.

The terminal displays each question on the display and accepts a single answer from the user per question. The terminal sends each answer to the server via the communication network using an application-layer protocol such as HTTPS. The server receives the answers and stores them as structured records in tables of the relational database, with each answer associated with question identification information and order information. The server normalizes text, for example by converting encodings to a unified character set, trimming whitespace, and standardizing punctuation, before inserting the data into the database.

The server reconstructs the answers stored in the database into an information profile for the target article. The server uses the question identification information and order information to assemble a deterministic structure such as a record containing named fields (for example, product name, region, characteristics, producer story, production method, recommended use). The server holds this information profile in a memory-resident data structure, for example as key-value pairs or an object in an object-relational mapping layer. This structure enables algorithmic processing of the data without re-parsing free-form input, thereby reducing CPU overhead and memory fragmentation when constructing subsequent prompt sentences.

The server generates a prompt sentence for a generative AI model for natural language generation by inserting the structured fields of the information profile into a text-generation template stored in the storage device. The text-generation template includes placeholders that are replaced at runtime with field values from the information profile. The server performs deterministic string concatenation and formatting, thereby avoiding ad hoc manual editing of prompts and enabling reproducible prompt construction.

For example, the server constructs a prompt sentence such as:

“Using the following information, generate a persuasive promotional text for a specialty product.

Product name: Aomori apples

Region: Aomori Prefecture, Hirosaki City

Characteristics: Very sweet, crisp texture, bright red color.

Producer's story: A family farm that has grown apples for three generations with reduced pesticides and a focus on quality.

Recommended use: Eating fresh and making apple pies.

Please highlight the unique taste, the clean local climate, and the passion of the producer in a warm and appealing tone.”

The server then sends this prompt sentence to a generative AI model deployed on a remote model-serving platform via an application programming interface. In one embodiment, the generative AI model for natural language generation is implemented as a large-scale neural network having a transformer architecture. The model includes multiple layers of self-attention, feedforward sub-networks, and layer normalization. The model represents each input token as a high-dimensional embedding vector, processes sequences of such vectors through stacked multi-head attention mechanisms, and outputs probability distributions over vocabulary tokens at each step.

The server transmits the prompt sentence as a sequence of tokens to the generative AI model. The generative AI model uses pre-trained parameters obtained by minimizing a loss function such as cross-entropy over a large corpus of training text. During training, the generative AI model is optimized by a gradient-based algorithm such as stochastic gradient descent with variants like Adam, updating weights in attention layers and feedforward layers based on backpropagation of prediction errors. In the deployed inference phase, the model applies the trained weights to compute output token probabilities without further weight updates.

The server controls model parameters such as sampling temperature, maximum token length, and decoding strategy (for example, greedy decoding or top-p sampling). This control causes the generative AI model to produce text that conforms to constraints required for marketing materials, such as specified length and style. The generated output includes appeal text that emphasizes the characteristics and background of the target article. The server receives the generated text data as a sequence of tokens, converts it into a character string, and performs deterministic post-processing, such as removing extraneous introductory phrases or adding paragraph breaks according to formatting rules.

The server stores the generated text data in the storage device, linked to the information profile. The server additionally converts the text into layout-ready fragments, such as title, subheading, and body paragraphs, based on rule-based parsing of sentence boundaries and keywords. This pre-segmentation reduces later computational overhead when assembling final documents.

The server then generates a prompt sentence for a generative AI model for image generation. The server selects relevant fields from the information profile and, optionally, from the generated appeal text, and inserts them into an image-generation prompt template. The server thereby produces a descriptive sentence that defines visual content, style, and context to be generated.

As an example, the server constructs the following prompt sentence:

“Generate a realistic, high-resolution marketing image of Aomori apples produced in Hirosaki City, Aomori Prefecture. Show a sunlit apple orchard with bright red apples on the trees, a clean blue sky, distant mountains, and a farmer gently holding freshly picked apples in the foreground. The style should be suitable for a printed brochure.”

In one embodiment, the generative AI model for image generation is implemented as a neural network based on a diffusion model or similar generative architecture. The model receives the text prompt as a sequence of embeddings produced by a text encoder, and then iteratively refines a latent representation of an image from noise to a coherent image by reversing a learned diffusion process.

During training, the diffusion model learns to predict noise added to images under various noise levels, optimizing a loss function such as mean squared error between predicted and actual noise.

The trained model, during inference, uses this learned denoising capability to transform random noise into structured image data that reflects the semantics of the prompt sentence.

The server transmits the image-generation prompt sentence to the image generative AI model. The model executes on GPU hardware, performing tensor operations to compute intermediate feature maps and update latent vectors across multiple denoising steps. The server receives image data in the form of encoded pixel arrays, for example in PNG format or as base64-encoded strings. The server decodes any encoded representation into binary image data, stores the image data in the storage device, and records metadata such as resolution, color space, and generation parameters.

The server further applies image post-processing operations, such as resizing, cropping, or compression, using an image processing library executed on the server CPU or GPU. By standardizing image dimensions and compression levels before document composition, the server reduces memory usage and network transmission volume when distributing completed marketing materials.

The server integrates the generated text data and image data into digital marketing materials. The server uses a document layout engine, such as a library of the type of a PDF generation library or an HTML-to-PDF converter. The server loads a layout template specifying positions of text blocks, image frames, fonts, and visual styles. The server inserts the text fragments and image references into placeholders in the layout template. The layout engine performs pagination, font rendering, image scaling, and placement operations, executing numeric computations on the server CPU to determine coordinates, bounding boxes, line breaks, and vector drawing commands.

The server outputs the final marketing material data in an electronic document format such as a portable document format file, and optionally in one or more image formats. The server writes the output file to the storage device and assigns a unique identifier and metadata, including timestamp, target article identifier, and file size. The server then exposes a download endpoint via the web server. The terminal accesses this endpoint, and the server streams the file over the communication network. The terminal stores the file locally and displays it using a PDF viewer or image viewer, rendering raster and vector data onto the display using the terminal's graphics subsystem.

In another embodiment, the server receives, from the terminal, refinement instructions after initial generation of marketing material data. The user may input emphasis-change information, such as “Emphasize that the apples are suitable as premium gifts,” expression-style-change information, such as “Use a more formal and elegant tone,” or visual-expression-change information, such as “Change the image style to watercolor illustration.” The terminal transmits these instructions to the server as structured data.

The server appends the refinement information to the information profile associated with the target article. The server modifies the text-generation template or image-generation prompt template according to deterministic rules. For example, the server adds a line to the text prompt specifying a change in tone:

“Please rewrite the promotional text to emphasize that these apples are ideal as premium gifts, and use a formal and elegant tone.”

Similarly, the server modifies the image-generation prompt:

“Generate a watercolor-style image of Aomori apples arranged in a premium gift box, suitable for a luxury catalog.”

The server reuses the existing structured profile data and applies only minimal incremental updates in the template. This reduces the need to recollect base product information, resulting in lower network traffic and fewer database writes. The server then re-invokes the generative AI models with these updated prompt sentences and repeats the combination and layout processes. By structuring refinement as a deterministic transformation of the information profile and templates, the server reduces trial-and-error prompting on the user's side and improves consistency across generations.

The server improves computer technology in several concrete ways. First, the server enforces the one-question-and-one-answer interaction and maintains structured information profiles with explicit identifiers and order information. This structure allows the server to generate prompt sentences algorithmically from stored data, rather than from unstructured free-form text. Because the server can systematically reconstruct profiles and template-based prompts, it reduces the number of generative calls needed to achieve acceptable output quality, thereby reducing processor cycles, memory usage, and external API calls.

Second, the server coordinates both text generation and image generation using a shared profile and controlled template system. This coordination causes the generative AI models to operate on more focused and consistent input, which improves the fidelity between text and images. As the server uses rule-based transformation of the profile to derive both text and image prompts, the server decreases semantic drift between modalities, reducing the need for manual correction and repeated generative processing, which are computationally expensive.

Third, the server uses deterministic post-processing and segmentation of generated text into document-ready fragments, and pre-processing of images into standardized sizes and formats. These steps reduce the computational load of the layout engine, enable parallelization of rendering steps, and support caching of intermediate results. As a result, the server can generate multiple marketing documents in a batch with improved throughput and lower memory overhead, providing a technical improvement in server-side document generation.

Fourth, the server exploits parameter control of the generative models (such as temperature, maximum tokens, diffusion steps, and guidance scales) based on profile complexity and resource constraints. The server can dynamically lower token limits or diffusion steps for simpler profiles to reduce latency, or adjust parameters upward for complex profiles. This adaptive control is implemented by comparing profile size and field diversity against predetermined thresholds, thereby providing an algorithmic optimization of generative processing that is not present in human-only workflows.

The neural architectures themselves are trained with computer-implemented learning algorithms that define concrete error functions and weight update procedures. For example, the transformer-based language model minimizes cross-entropy loss between predicted and actual tokens over a large corpus; the diffusion-based image model minimizes mean squared error between predicted noise and true noise. These models are optimized using batch processing, gradient clipping, and learning-rate scheduling techniques. By exploiting these learned mappings, the server applies complex, non-linear transformations that are not feasible with simple rule-based human scripting alone and that achieve higher accuracy in aligning prompts with outputs than naive automation.

The server thus realizes a system in which the internal data structures (information profiles, templates, layout metadata) and the external generative AI models are technically integrated. This integration, together with structured input, prompt construction algorithms, adaptive parameter control, and standardized document composition, yields a technical effect of improved processing speed, reduced network and computation load, and enhanced consistency and quality of generated digital documents across multiple sessions and devices. The user interacts only through the terminal, and the underlying improvements occur in the server's internal data management, model control, and rendering subsystems, thereby improving the functioning of the computer system itself rather than merely automating a human mental process.

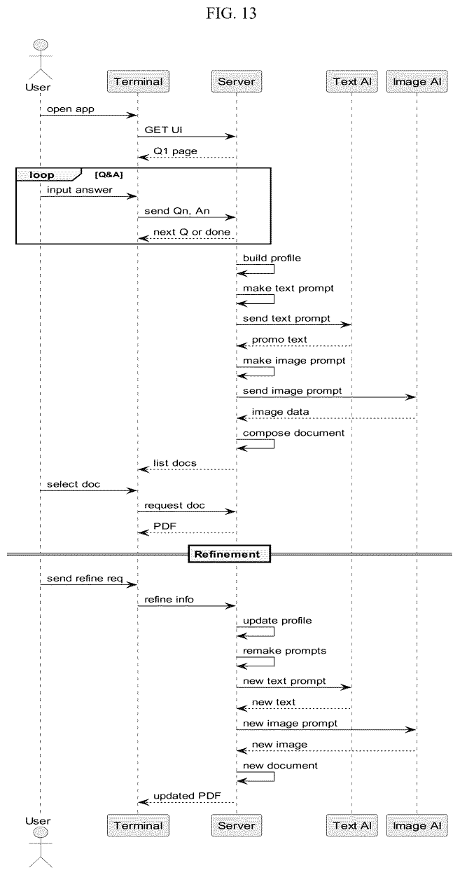

The following describes the processing flow using FIG. 13.

### Step 1

The user operates the terminal to access a web page provided by the server over a communication network. The terminal sends an HTTP request to the server as input, requesting an interface for entering information about a target article. The server outputs an HTML/JavaScript page that implements a one-question-and-one-answer interface, including the first question and associated metadata.

### Step 2

The terminal displays the first question on the display and waits for user input. The user inputs an answer, such as a product name, using a keyboard or touchscreen. The terminal takes the question identifier and the entered text as input, packages them into a structured message (for example, a JSON object with fields “question_id” and “answer”), and outputs this message to the server via HTTPS.

### Step 3

The server receives the structured message from the terminal. The server takes the question identifier, the text answer, and a session or user identifier as input. The server performs data validation (for example, checking that the text is not empty and within a length limit) and text normalization (for example, trimming whitespace and normalizing encoding). Based on this processing, the server outputs a database record that stores the answer together with the question identifier and a sequence index in a relational database.

### Step 4

The server determines whether all questions in a predefined question set have been answered. The server takes as input the session identifier and queries the database for all stored answers associated with that session. The server performs a comparison between the set of stored question identifiers and the set of required question identifiers. If not all required identifiers are present, the server outputs the next question (including its identifier and text) to the terminal.

### Step 5

The terminal receives the next question from the server and updates the displayed content. The terminal takes as input the question text and identifier from the server response, replaces the previous question on the screen, and outputs a new user interface state that prompts the user for an additional answer. The user again enters text, and the terminal outputs another structured message to the server. Steps 2 through 5 are repeated until all required questions have been answered.

### Step 6

When all required questions have been answered, the server reconstructs an information profile for the target article. The server takes as input all answer records associated with the session from the database, including question identifiers, sequence indices, and answer texts. The server sorts the records by sequence index, maps each record to a corresponding profile field (for example, product name, region, characteristics, provider story, usage pattern), and aggregates these fields into a structured profile object in memory. The server outputs this information profile as a data structure ready for prompt construction.

### Step 7

The server generates a prompt sentence for a generative AI model for natural language generation.

The server takes as input the information profile and a stored text-generation template. The server performs string substitution, in which placeholder tokens in the template are replaced with corresponding field values from the profile, and concatenates static instructional text with these substituted values. For example, the server constructs a prompt sentence such as:

“Using the following information, generate a persuasive promotional text for a specialty product.

Product name: Aomori apples

Region: Aomori Prefecture, Hirosaki City

Characteristics: Very sweet, crisp texture, bright red color.

Producer's story: A family farm that has grown apples for three generations with reduced pesticides and a focus on quality.

Recommended use: Eating fresh and making apple pies.

Please highlight the unique taste, the clean local climate, and the passion of the producer in a warm and appealing tone.”

The server outputs this prompt sentence as a character string.

### Step 8

The server sends the prompt sentence to a generative AI model for natural language generation. The server takes as input the prompt sentence, model configuration parameters (such as maximum token count and sampling temperature), and authentication information for an external model-serving API.

The server executes an HTTP request to the model-serving endpoint, performing encoding of the prompt into a request body. The generative AI model processes the prompt sentence via its neural network computations and returns generated text as output. The server receives the model response, decodes it from the response format, and outputs generated text data that includes appeal text describing the target article.

### Step 9

The server post-processes and stores the generated text data. The server takes as input the raw text produced by the generative AI model and the associated session or profile identifier. The server performs data operations including trimming extraneous phrases, segmenting the text into paragraphs based on punctuation and length, and optionally extracting a summary for preview. The server outputs cleaned and segmented text data, which is then inserted into the database and linked to the information profile by a foreign key.

### Step 10

The server generates a prompt sentence for a generative AI model for image generation. The server takes as input the information profile and the cleaned appeal text. The server applies rule-based logic to select key phrases (for example, product name, region, characteristic descriptors, and scene elements) and inserts them into an image-generation template. The server may also append style instructions, such as “realistic,” “watercolor,” or “for a printed brochure,” based on configuration or user preferences. For example, the server constructs a prompt sentence such as:

“Generate a realistic, high-resolution marketing image of Aomori apples produced in Hirosaki City, Aomori Prefecture. Show a sunlit apple orchard with bright red apples on the trees, a clean blue sky, distant mountains, and a farmer gently holding freshly picked apples in the foreground. The style should be suitable for a printed brochure.”

The server outputs this image-generation prompt sentence as a character string.

### Step 11

The server sends the image-generation prompt sentence to a generative AI model for image generation. The server takes as input the prompt sentence and image-generation parameters (such as requested resolution and number of images). The server encodes this information into an API request to a model-serving system that hosts a diffusion-based or similar generative image model. The generative AI model converts the text to an internal representation and performs iterative denoising steps on latent image data, and then returns image data as output. The server receives a response containing, for example, a URL or base64-encoded image. The server decodes or downloads the image data and outputs binary image data representing the generated image.

### Step 12

The server normalizes and stores the generated image data. The server takes as input the binary image data, the profile identifier, and any generation metadata such as resolution and model parameters. The server performs processing operations, including conversion to a standard format (for example, PNG), resizing to a standard dimension suitable for layouts, and optional compression.

The server outputs a standardized image file stored in a file system or object storage, and writes a database record containing a reference path or URL and metadata linked to the profile.

### Step 13

The server composes marketing material data by integrating the text data and image data. The server takes as input the cleaned text fragments, the standardized image reference, and layout template information that specifies how to arrange elements on a page. The server executes a document generation engine, which performs layout calculations such as line breaking, paragraph flow, font rendering, and placement of the image within predefined frames. The server outputs a finalized document in an electronic document format, for example a PDF file, and may additionally output one or more raster images representing pages.

### Step 14

The server registers the generated marketing material data for delivery. The server takes as input the file path or storage identifier of the generated document and the corresponding profile or user identifier. The server writes a record into a database table that relates the document to the user and the target article, and computes ancillary data such as file size and timestamp. The server outputs a discoverable reference that can be requested by the terminal to download or display the document.

### Step 15

The terminal requests a list of available marketing materials. The terminal takes as input a user action, such as the user selecting a “View generated materials” option. The terminal sends a request to the server containing the user or session identifier. The server queries the database for all documents associated with that identifier and outputs a list that includes metadata such as document title, creation time, and thumbnail image references. The terminal receives this list and outputs a visual representation on the display, showing the available materials to the user.

### Step 16

The user selects a specific marketing material to view or download. The terminal takes as input the user's selection, identifies the corresponding document reference, and sends a download request to the server. The server reads the document file from storage using the reference as input, streams the file data back to the terminal, and outputs the file over the communication network. The terminal receives the file, stores it locally, and outputs the rendered content on the display using a document viewer.

### Step 17

The user provides refinement instructions for the generated content. The terminal takes as input user-supplied text such as “Emphasize that these apples are suitable as premium gifts” or “Change the image style to watercolor illustration.” The terminal sends these refinement instructions, together with an identifier of the associated marketing material or profile, to the server. The server receives this information as input, updates the information profile by appending emphasis-change information, expression-style-change information, or visual-expression-change information, and outputs an updated profile state.

### Step 18

The server regenerates prompt sentences and content based on the refinement instructions. The server takes as input the updated information profile and the original text-generation and image-generation templates. The server modifies the templates or prompt sentences by inserting the refinement instructions, for example by adding lines such as “Please rewrite the promotional text to emphasize that these apples are ideal as premium gifts, and use a formal and elegant tone.” for text, or “Generate a watercolor-style image of Aomori apples arranged in a premium gift box, suitable for a luxury catalog.” for images. The server outputs revised prompt sentences for both the text generative AI model and the image generative AI model, re-invokes those models using the same procedures as in Steps 8 and 11, and produces updated text data and image data. The server then generates updated marketing material data using the same composition and storage operations as in Steps 12 and 13, thereby outputting revised documents that reflect the user's refinement while reusing the underlying structured profile and computational resources efficiently.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”

Conventional computer-implemented content generation systems that use generative artificial intelligence models to create marketing or advertising materials typically operate in a static and one-shot manner. A conventional server usually collects product information, constructs a single prompt for a generative AI model, receives generated text or an image, and then delivers a fixed digital document to a terminal. Such architectures exhibit several technical limitations from a computer-technology perspective.

First, conventional systems do not maintain a structured, feedback-driven loop between the user's real-time emotional state and the ongoing generation of content by the generative AI model. In typical implementations, the server is not configured to acquire user expression information (such as facial expression data or voice data) from a display-side information processing apparatus, to infer an emotion state via an emotion estimation model, and to feed that emotion state back into the prompt sentence used for the generative AI model. As a result, the server cannot dynamically reconfigure prompts or generation parameters based on the current user state, and the generated content remains static and insensitive to user reactions.

Second, conventional systems lack a coordinated mechanism at the processor level for integrating multiple modalities-namely, structured attribute information of a target article, generative text output, generative image output, and emotion-state data-into a unified, real-time update pipeline.

The processor typically does not orchestrate storage, retrieval, and transformation of these heterogeneous data types in a way that supports iterative regeneration of prompt sentences and regenerated electronic material with low latency. This leads to inefficiencies in processing, redundant calls to generative AI services, higher network and compute load, and difficulty in maintaining temporal consistency between what the user feels and what is displayed.

Third, in many existing systems, user emotion analysis, when present, is only used for offline analytics or coarse-grained segmentation. It is not tightly bound to runtime control flow of the server, and therefore is not used to directly control, at run time, how prompt sentences are constructed or how generative AI models are invoked. Consequently, servers in such architectures are unable to improve their internal behavior-such as prompt generation logic, model invocation cadence, and electronic material assembly—in response to fine-grained, real-time emotion signals, which is a missed opportunity to optimize system-level performance, responsiveness, and user engagement.

Fourth, conventional systems do not provide a clear separation and coordination between (i) real-time, emotion-adaptive electronic material that changes frequently, and (ii) static, exportable electronic material that must remain stable for archiving or sharing. Without processor-level mechanisms for generating persistent reference information for a frozen snapshot of text and images, servers tend to duplicate expensive generative AI computations or to mix mutable and immutable content, which complicates cache strategies, increases storage overhead, and degrades maintainability of the system.

Accordingly, there is a need for an improved computer-based system and server logic that (1) systematically collects and stores target article information, (2) generates prompt sentences for generative AI models in a structured way, (3) incorporates real-time emotion-state estimation derived from expression information provided by a display-side apparatus, (4) regenerates prompt sentences and electronic material in accordance with changes in the emotion state, and (5) distinguishes between real-time-updatable material and static material. Such a system should improve the operation of the computer itself by providing more efficient use of generative AI resources, better synchronization between user state and displayed content, reduced redundant processing, and improved control over the lifecycle of generated electronic material.

The specific processing by the specific processing unit 290 of the data processing device 12 in Application Example 2 is realized by the following means.

The present invention provides a server comprising a processor configured to electronically collect, via an information processing apparatus, information regarding attributes, processes, and origins of a target article, to store the collected information in a storage unit, to generate, based on the stored information, a first prompt sentence including an instruction text for a language-generation generative artificial intelligence model, to cause a natural language processing apparatus using the generative artificial intelligence model to generate appeal text information in response to the first prompt sentence, to generate, based on the stored information and the appeal text information, a second prompt sentence including an instruction text for an image-generation generative artificial intelligence model, to cause an image generation apparatus using the generative artificial intelligence model to generate visual representation image information in response to the second prompt sentence, to acquire expression information of a user from a display information processing apparatus, to specify an emotion state of the user by applying an emotion estimation model to the expression information, to regenerate, based on the emotion state and the stored information, at least one updated prompt sentence that explicitly includes the emotion state as an input condition to the generative artificial intelligence model, to cause the generative artificial intelligence model to additionally generate emotion-adaptive appeal text information and/or emotion-adaptive visual representation image information in response to the updated prompt sentence, to integrate the appeal text information, the visual representation image information, and the emotion-adaptive appeal text information and/or the emotion-adaptive visual representation image information into electronic material for visual output, to provide the electronic material to the display information processing apparatus via a communication network, to repeatedly update generation of the prompt sentences and generation of the electronic material according to changes in the emotion state so that the electronic material is updatable in real time, and to selectively generate static electronic material in which the appeal text information and the visual representation image information are fixed at a predetermined time and associate persistent reference information with the static electronic material for storage and sharing. This enables the computer system to implement a feedback-controlled content generation pipeline in which the processor dynamically constructs and updates prompt sentences for generative AI models based on real-time emotion-state input, efficiently coordinates storage and retrieval of multimodal data, reduces redundant generative processing by separating real-time and static outputs, and improves overall responsiveness, resource utilization, and synchronization between the user's current state and the electronic material presented on the display information processing apparatus.

The term “system” refers to a combination of one or more hardware devices, software components, and communication interfaces that cooperatively perform the functions described in the claims.

The term “processor” refers to one or more hardware processing units, such as a central processing unit, a microprocessor, or a processing core, configured to execute instructions and thereby implement the claimed functions.

The term “information processing apparatus” refers to a computing device or a computing subsystem that is configured to acquire, transmit, or process information related to a target article, including but not limited to a server, a client device, or a terminal.

The term “display information processing apparatus” refers to a computing device that includes a display unit and is configured to present electronic material to a user and to acquire expression information from the user, such as a smartphone, a tablet, a head-mounted display, or a similar visual output device.

The term “target article” refers to any item, product, service, or subject matter for which attributes, processes, and origins are collected and for which appeal text information and visual representation image information are generated.

The term “attributes” refers to descriptive data of a target article, including but not limited to physical characteristics, functional properties, quality indicators, and other identifying information.

The term “processes” refers to manufacturing processes, operational processes, or procedural steps associated with the target article, including how the article is produced, handled, or provided.

The term “origins” refers to background information regarding the target article, including but not limited to geographic origin, historical context, production environment, and conceptual background.

The term “storage unit” refers to any hardware or software component configured to store data, such as a memory device, a database system, a storage medium, or a storage service.

The term “generative artificial intelligence model” refers to a machine-learning model configured to generate output data, such as text or images, in response to input data, including but not limited to neural network models trained for generative tasks.

The term “language-generation generative artificial intelligence model” refers to a generative artificial intelligence model that is configured to generate natural-language text based on an input prompt sentence.

The term “image-generation generative artificial intelligence model” refers to a generative artificial intelligence model that is configured to generate image data, such as raster images or vector images, based on an input prompt sentence.

The term “prompt sentence” refers to a textual input, which may include an instruction part and a data part, that is provided to a generative artificial intelligence model to specify a task and to condition the generation output.

The term “instruction text” refers to a portion of a prompt sentence that explicitly describes to the generative artificial intelligence model what type of output to generate and under what style, tone, or constraints.

The term “natural language processing apparatus” refers to a software module, hardware module, or combination thereof, which utilizes a language-generation generative artificial intelligence model to generate or transform natural-language text.

The term “image generation apparatus” refers to a software module, hardware module, or combination thereof, which utilizes an image-generation generative artificial intelligence model to generate image data.

The term “appeal text information” refers to text data generated by a natural language processing apparatus that is intended to describe or promote the target article, including but not limited to marketing phrases, explanatory sentences, and descriptive paragraphs.

The term “visual representation image information” refers to image data generated by an image generation apparatus that visually represents the target article, its context, or its characteristics.

The term “expression information” refers to data related to observable expressions or reactions of a user, including but not limited to facial expression data, body-movement data, gaze data, and voice data.

The term “emotion estimation model” refers to a computational model configured to receive expression information and to output an estimated emotion state of a user.

The term “emotion state” refers to a representation of a user's emotional condition derived from expression information, such as joy, interest, excitement, anxiety, or other affective states, optionally with associated confidence values.

The term “emotion-adaptive appeal text information” refers to appeal text information generated based on a prompt sentence that explicitly includes an emotion state of a user so that the generated text is adapted to that emotion state.

The term “emotion-adaptive visual representation image information” refers to visual representation image information generated based on a prompt sentence that explicitly includes an emotion state of a user so that the generated image is adapted to that emotion state.

The term “electronic material” refers to digital content that includes at least appeal text information and visual representation image information, and optionally emotion-adaptive information, arranged for presentation on a display information processing apparatus.

The term “visual output” refers to the presentation of electronic material on a display device, including the rendering of text and images for perception by a user.

The term “communication network” refers to any wired or wireless network infrastructure that enables data exchange between the server, the display information processing apparatus, and other components, including local networks and wide-area networks.

The term “real time” refers to processing and updating of electronic material with a latency that is sufficiently low for changes in emotion state to be reflected in the displayed content while the user is still engaged with the material.

The term “static electronic material” refers to electronic material in which the appeal text information and the visual representation image information are fixed at a particular time and are not automatically updated in response to subsequent changes in emotion state.

The term “persistent reference information” refers to identifier information, such as a uniform resource identifier or a similar reference, that uniquely associates with static electronic material to allow later retrieval, storage, or sharing.

The term “external apparatus” refers to any device or system other than the system and the display information processing apparatus, including but not limited to another user device, a printing device, or a remote server.

### A. Overall Hardware and Software Configuration

The server uses one or more physical computing machines each including at least one central processing unit, a main memory, a nonvolatile storage device, and a network interface. The server executes an operating system such as a general-purpose server operating system and a set of application programs implementing the claimed functions. The server further uses a database management system, such as a relational database management system (for example, a system of the MySQL type), to store information regarding target articles, generated text, generated images, and user emotion states.

The terminal uses a computing device such as a smartphone, tablet, notebook computer, smart glasses, or head-mounted display that includes a display unit, an input unit (touch panel, buttons, or pointing device), a camera device, a microphone device, a local processor, a volatile memory, a nonvolatile memory, and a wireless or wired communication interface. The terminal executes an operating system for mobile or desktop devices and an application or web client that communicates with the server via a communication network.

The server uses one or more generative AI models deployed as services. For text generation, the server uses a language-generation generative AI model that can be implemented as a transformer-based neural network with multiple attention layers, trained on large-scale text corpora. For image generation, the server uses an image-generation generative AI model that can be implemented as a diffusion-type neural network or a transformer-based image generator, trained to map textual prompt sentences to raster images. The server accesses these generative AI models via an application programming interface exposed by an AI service platform.

The server further uses an emotion estimation model. In one embodiment, the server uses an emotion estimation model that receives facial feature vectors and audio feature vectors and outputs an emotion state vector. The model may be implemented as a combination of convolutional neural networks for image features and recurrent or transformer-based networks for audio features. The server may use a commercial software development kit or cloud service that implements such models, or may deploy a custom-trained model.

### B. Data Structures and Data Flow

The server uses structured data records to manage information. For target articles, the server stores records that include at least an article identifier, attribute fields (name, category, physical characteristics), process fields (manufacturing steps, handling procedures), origin fields (geographical origin, historical background), and additional metadata. These records are stored in tables of the relational database and are indexed by the article identifier.

The server uses separate tables to store text generation results (appeal text information) and image generation results (visual representation image information). Each record in these tables includes a reference to the article identifier, a version identifier, a timestamp, and content fields (for example, a text field for the appeal text, and a file path or uniform resource locator for the image).

The server uses a table for emotion-related data. Each record in this table can include a session identifier, a time index, an emotion state vector (for example, probabilities for multiple emotion categories), and auxiliary information such as confidence values.

The server arranges data flow such that target article information flows from a storage stage, through a prompt construction stage, through a generative AI invocation stage, to an integration stage, and then to a distribution stage. In parallel, expression information from the terminal flows through an emotion feature extraction stage and an emotion estimation stage, and then back to the prompt construction stage where it modifies future prompt sentences. This feedback loop allows the system to create emotion-adaptive electronic material that is updated in real time.

### C. Collection and Storage of Target Article Information

The server uses an information processing apparatus function to collect information regarding attributes, processes, and origins of a target article. In one embodiment, the server exposes a network-based user interface, such as a web interface accessible from the terminal. The server causes the terminal to display fields or questions requesting article name, category, physical features, manufacturing method, origin region, production history, and producer's remarks.

The user operates the terminal to input such information via the input unit. The terminal constructs a set of key-value data items and transmits them to the server via a secure communication protocol.

The server receives these data items, verifies their format, normalizes encoding, and performs validation such as length checks, character set checks, and missing field checks. The server then stores the validated information into the database tables as records for the target article.

The server thereby ensures that the information required to construct prompt sentences for the generative AI models is maintained in a structured and indexed manner. This improves data management compared to ad-hoc text storage and reduces search time and parsing overhead in subsequent processing.

### D. Construction of Prompt Sentences for Generative Text

The server uses the stored article information to construct a prompt sentence for the language-generation generative AI model. The server retrieves the corresponding record from the database by executing a query keyed by the article identifier. The server concatenates several fields into descriptive strings and formats them into a template for prompt construction.

In one example, the server constructs a prompt sentence of the form:

“You are a professional marketing writer. Using the following product information, generate an appealing advertisement text.

Product name: Aomori Apple

Region: Aomori, Japan

Features: crisp texture, rich sweetness, grown with reduced pesticides

Producer's thoughts: ‘We want families to enjoy safe, delicious apples every day.’

Please generate a persuasive and informative appeal text in natural language.”

The server may include control tokens or special delimiters that the generative AI model recognizes as separators between instruction text and data portions. The server may also include parameters such as desired output length, tone (formal or casual), and target audience description, encoded as additional phrases in the prompt sentence.

The server then sends this prompt sentence to the language-generation generative AI model via an application programming interface. The server specifies parameters such as temperature, top-k or top-p sampling values, and maximum token count. These parameters determine the stochastic behavior, diversity, and length of the generated text. The generative AI model internally uses a transformer-based architecture that computes attention matrices over the prompt tokens and iteratively predicts subsequent tokens until the maximum length or an end-of-sequence token is reached.

The server receives the generated token sequence, decodes it into text, performs post-processing such as trimming white spaces, removing undesired prefixes, and replacing non-printable characters, and then stores the resulting appeal text information in the database linked to the article identifier.

This prompt-based control is not a mere automation of human copywriting. By structurally separating instruction segments and data segments in the prompt sentence and applying tuned parameters, the server creates a consistent interface to the generative AI model that allows repeatable, machine-controlled generation for many articles with minimal human intervention. This yields technical improvements such as reduced manual configuration time, improved reuse of prompt patterns, and predictable variability in outputs.

### E. Construction of Prompt Sentences for Generative Images

The server also constructs prompt sentences for the image-generation generative AI model. The server extracts from the article record and appeal text record key phrases that indicate visual attributes, such as color, shape, environment, and style. The server may employ a rule-based text analysis routine that searches for keywords in the appeal text (for example, “mountain,” “wooden table,” “traditional,” “modern”) and maps them to visual attributes.

In one example, the server constructs the following prompt sentence:

“Generate a high-resolution image of vivid red Aomori apples in a wooden crate, placed in front of green mountains and a blue sky in northern Japan, in a bright, realistic photographic style.”

The server applies this prompt sentence to the image-generation model by sending a request to an image-generation service. The server also specifies image parameters such as resolution (for example, 1024× 1024 pixels), aspect ratio, color mode, and number of output candidates.

The image-generation generative AI model may use a diffusion process that iteratively refines a noise image into a coherent output, conditioned on the textual embedding of the prompt sentence.

The model may internally represent text tokens via an encoder network and feed these embeddings into a denoising neural network that gradually adjusts the pixels. The server does not alter this model's training but controls its operation by precise prompt sentences and parameter values.

The server receives the resulting image data in a compressed format such as PNG or JPEG, stores the image file in a file system or object storage, and stores a reference path or uniform resource locator in the database linked to the article identifier. The server may also use an image processing library to downsample or crop the image to create variants appropriate for different display resolutions.

### F. Acquisition of Expression Information and Emotion Estimation

The terminal acquires expression information of the user while the user is viewing electronic material. The terminal activates its camera and microphone when permitted by the user. The terminal captures image frames of the user's face at a predetermined rate, such as 15 or 30 frames per second, and captures short segments of audio during the viewing session.

The terminal either transmits these raw data streams to the server or locally extracts feature vectors.

In one embodiment, the server receives raw image frames and audio samples over a secure channel and stores them temporarily in a memory buffer. The server then uses an emotion estimation model to process the expression information.

The server first extracts facial features by applying a face-detection algorithm, such as a multi-stage convolutional network, to locate regions of interest. The server then uses a convolutional neural network trained on facial emotion datasets to convert each face region into a feature vector that captures facial muscle patterns. For audio, the server computes mel-frequency cepstral coefficients or similar spectral features from the audio segments and feeds them into a recurrent or transformer-based network trained to detect emotional cues in speech.

The emotion estimation model combines the visual and audio feature vectors, for example by concatenation followed by fully connected layers, and outputs a probability vector over a set of emotion categories, such as joy, excitement, curiosity, anxiety, or dissatisfaction. The model may use a softmax layer as its final layer and may be trained by gradient-descent methods using a cross-entropy loss over labeled emotion datasets.

The server interprets the probability vector and selects as the emotion state the category whose probability exceeds a threshold or is maximal. The server thereby obtains a structured emotion state value with confidence measures and stores this in the emotion table associated with the viewing session.

This emotion estimation pipeline provides technical advantages compared to simple user feedback mechanisms such as button presses or surveys. The pipeline can operate continuously with low latency, enabling the server to react almost immediately to subtle changes in facial expressions and voice patterns, which would be difficult or slow for human operators to capture.

### G. Emotion-Adaptive Prompt Re-Generation and Content Adaptation

The server uses the emotion state to regenerate prompt sentences for the generative AI models. The server defines rule sets that map emotion categories to content strategies. For example, when the emotion state is classified as “excitement,” the rule may indicate that the server should request more emphatic language and dynamic images. When the emotion state is classified as “anxiety,” the rule may indicate that the server should request more explanatory, reassuring language and calm imagery.

The server uses these rules to construct updated prompt sentences. For text, the server may generate a prompt sentence such as:

“The customer is feeling strong excitement about this product. Based on the following product information and existing appeal text, please generate an additional marketing sentence that amplifies this excitement and encourages purchase, while remaining accurate and trustworthy.

[Product information and existing appeal text follow here.]”

For a user expressing anxiety, the server may construct the following prompt sentence:

“The customer is feeling anxiety about the safety and reliability of this product. Based on the following product information, please generate a reassuring paragraph that clearly explains safety measures, quality control procedures, and certifications, in a calm and trustworthy tone.

[Product information follows here.]”

The server sends these updated prompt sentences to the language-generation generative AI model with possibly different parameter settings optimized for clarity or emphasis. The model generates emotion-adaptive appeal text information. The server stores the generated text as additional records or as appended sections in the existing appeal text.

For images, the server may construct prompt sentences for the image-generation model such as:

“Generate an image of the product with energetic lighting, vivid colors, and a dynamic composition that emphasizes excitement and joy.” or

“Generate an image of the product in a clean, calm environment with soft lighting and visible safety labels to reassure the customer.”

The server thus uses the emotion state not only as a statistical label but as a direct constraint in the prompt sentence, guiding the generative AI models to produce content tailored to the current emotion.

By controlling prompt sentences in this emotion-aware manner, the server achieves machine-level reconfiguration of generative AI behavior that dynamically adapts to user signals. This reduces the time and number of iterations needed to converge to content that matches user expectations, thereby improving processing efficiency and reducing redundant generative calls.

### H. Integration and Distribution of Electronic Material

The server integrates the appeal text information, visual representation image information, and emotion-adaptive information into electronic material. The server uses templates for digital documents, such as HyperText Markup Language templates or markup templates for portable document format generation. The server replaces placeholder fields in the template with the current text segments and image identifiers retrieved from the database.

The server, in one embodiment, designates separate regions in the template for base appeal text and emotion-adaptive text. The server may conditionally include or exclude sections of content depending on the currently active emotion state. The server then renders the template to generate a final electronic document, either as an HTML page for immediate display or as a PDF file for later download.

The server transmits the resulting electronic material to the terminal via the communication network.

The terminal receives the material and renders it on the display unit. The terminal may also maintain a connection to poll or subscribe to updates from the server. When the server generates a new version of the electronic material in response to a new emotion state, the server sends a notification or updated material, and the terminal updates the display accordingly.

This configuration allows real-time updates of the displayed content without requiring the user to reload pages or manually request updates. The technical effect is a reduction in perceived latency and network overhead, because the server updates only the parts of the material that depend on emotion changes and the terminal does not repeatedly download unchanged components.

### I. Generation of Static Electronic Material

The server additionally generates static electronic material that is not subject to further emotion-based updates. When the system reaches a certain condition, such as the end of a session or at the user's request, the server selects the current appeal text information and visual representation image information as a final configuration and generates a snapshot document.

The server renders this snapshot into a file, such as a PDF leaflet or a static HTML page, and stores it in storage with an associated persistent reference identifier, such as a uniform resource identifier.

The server transmits this reference to the terminal. The terminal, upon receiving this reference, can store it locally, present it to the user, or share it with an external apparatus, such as a printer, another user device, or a remote archive.

This separation between dynamic, emotion-adaptive material and static snapshots helps avoid unnecessary regeneration of content. The server can cache static materials and reuse them across sessions, which reduces computational load and decreases the number of calls to external generative AI services. This leads to reduced processing cost and improved scalability.

### J. Technical Effects and Improvements to Computer Technology

The server, terminal, and associated models cooperate to provide several technical improvements beyond mere automation of human tasks.

First, by using structured data records for article information, emotion states, and generated content, the server reduces the complexity and time of retrieving and updating relevant data for each generative AI invocation. Indexing and schema design lead to faster query execution and lower memory usage.

Second, by constructing prompt sentences in a controlled and structured way, the server enables the generative AI models to be used as deterministic components of a larger system rather than as ad-hoc tools. The server maintains templates and parameter configurations that reduce variance and errors in generation, which directly contributes to more predictable resource usage and fewer retries.

Third, by integrating emotion estimation models into the server's control logic, the system enables feedback-based adaptation of generative processing. The server uses concrete emotion signals derived by specific neural network architectures, with predefined loss functions and feature extraction methods, to adjust prompt content and generation parameters. This feedback closes a loop between sensing, decision, and content generation and thereby improves the responsiveness of the displayed material.

Fourth, by providing mechanisms for distinguishing between real-time-updatable material and static material, and by associating persistent references with the static material, the server reduces redundant computations and network transmissions. This is a technical effect on system performance rather than a mere business optimization.

Fifth, the underlying generative models and emotion models are trained by supervised and self-supervised learning. During training, the models use gradient-based optimization methods that iteratively adjust weights based on error functions such as cross-entropy loss for language tokens, mean squared error for image reconstruction, and classification loss for emotion labels. The server, when deploying these models, uses their internal architectures in a specific way by feeding carefully structured prompt sentences and input features. The combination of model architecture and prompt structure provides an improvement in output quality and error rates compared to naive free-form prompts.

Sixth, the system uses non-conventional processing order by first generating base content, then measuring user emotion in real time, and then regenerating refined content. This differs from simple batch generation or one-shot rendering and provides iterative refinement that is guided not only by abstract business rules but by the concrete sensor-derived state of the user. This yields technical benefits in terms of output relevance and time to converge on desired content.

### K. Variations and Alternative Embodiments

The server may, in other embodiments, run the language-generation generative AI model and image-generation generative AI model locally instead of calling remote services. In such cases, the server may use dedicated hardware accelerators such as graphics processing units or tensor-processing units and may store the model parameters in local storage. The basic prompt sentence construction and emotion feedback mechanism remain the same.

The terminal may, in another embodiment, execute the emotion estimation model locally, using a mobile-optimized neural network. In this case, the terminal sends only emotion state values to the server, which can reduce communication bandwidth and improve privacy.

The server may also employ additional feature extraction techniques for article information, such as topic modeling or embedding generation, to enrich the prompt sentences. The server may maintain multiple prompt templates and select one based on article category or user preferences to further optimize generative behavior.

The invention is not limited to marketing materials. The same architecture can be applied to educational content, technical manuals, or interactive guides, where the generative AI model adjusts explanations or images based on user confusion, interest, or frustration detected by the emotion estimation model. The hardware, software, and data processing flows described above remain substantially the same, and the technical effects of improved responsiveness, resource efficiency, and data management continue to apply.

Through these configurations and variations, the server, terminal, and user interactions as described allow the invention to be implemented in a manner that supports the scope of the claims and provides concrete improvements to computer-based generative content systems.

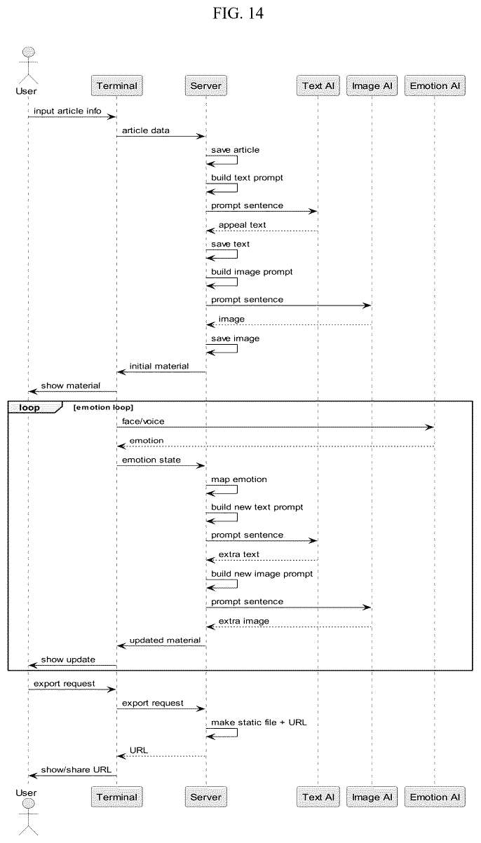

The following describes the processing flow using FIG. 14.

### Step 1

The user operates the terminal to input basic information regarding a target article.

The terminal displays input fields and one-question-one-answer prompts for attributes (name, category, physical characteristics), processes (manufacturing or handling steps), and origins (region, historical background, producer's remarks).

Input: raw keystrokes or touch events corresponding to user-entered text and selections.

The terminal converts the input events into structured data items (for example, key-value pairs for “name,” “region,” “feature,” “history,” “producer_message”) and performs client-side validation such as checking that mandatory fields are not empty.

Output: a structured information object ready for transmission to the server.

### Step 2

The terminal transmits the structured information object to the server.

Input: the structured information object created in Step 1.

The terminal encapsulates the object into a network message (for example, an HTTP POST request with a JSON body), adds session identifiers and authentication tokens, and sends the message to a predefined server endpoint over a secure protocol.

Output: a network request containing the article information, delivered to the server.

### Step 3

The server receives and stores the article information in a storage unit.

Input: the network request with structured article information and session information.

The server parses the request body, verifies syntax and semantics (for example, type checking, length limits, allowed character sets), and rejects or corrects malformed fields. The server then maps the validated fields to columns in a relational database schema and performs an INSERT or UPDATE operation.

Output: a stored article record identified by an article identifier and accessible via database queries.

### Step 4

The server prepares data for constructing a prompt sentence for a language-generation generative AI model.

Input: the stored article record retrieved from the database by article identifier.

The server normalizes text encoding to a unified format, trims unnecessary whitespace, and concatenates multiple fields (for example, features, process description, and origin story) into a coherent descriptive segment. The server optionally computes derived metadata (for example, a short summary) using rule-based text processing.

Output: a normalized article description object ready to be embedded into a prompt sentence.

### Step 5

The server constructs a prompt sentence for generating appeal text using the generative AI model.

Input: the normalized article description object and configuration parameters such as desired tone, length, and target audience.

The server inserts the description into a pre-defined template that separates instruction text from data. For example, the server may construct:

“You are a professional marketing writer. Using the following product information, generate an appealing advertisement text.

Product name: Aomori Apple

Region: Aomori, Japan

Features: crisp texture, rich sweetness, grown with reduced pesticides Producer's thoughts: ‘We want families to enjoy safe, delicious apples every day.’

Please generate a persuasive and informative appeal text in natural language.”

The server concatenates all segments into a single prompt sentence (or block) and attaches generation parameters such as temperature and maximum token count.

Output: a complete prompt sentence and associated generation parameters for the language-generation generative AI model.

### Step 6

The server requests appeal text from the language-generation generative AI model.

Input: the prompt sentence and generation parameters created in Step 5.

The server formats an API request payload, sends it via network to the generative AI model service, and waits for a response. Internally, the model encodes the prompt tokens, runs attention-based computations across transformer layers, and samples output tokens according to the specified parameters. The server monitors for timeouts and retries as needed.

Output: a generated token sequence representing appeal text, received in the response payload.

### Step 7

The server post-processes and stores the generated appeal text.

Input: the raw generated token sequence or text returned by the generative AI model.

The server decodes tokens into text, removes extraneous markers (such as leading “Answer:” prefixes), standardizes line breaks, and applies content filters (for example, forbidden word replacement or truncation at a sentinel phrase). The server then associates the cleaned text with the article identifier and writes it as a new record in the appeal-text table in the database.

Output: a stored appeal text record linked to the corresponding article record.

### Step 8

The server extracts visual cues and constructs a prompt sentence for the image-generation generative AI model.

Input: the article record and the stored appeal text record.

The server analyzes the text fields to identify visual attributes (such as color, environment, style) using keyword matching or simple natural language heuristics. Based on these attributes, the server builds a descriptive sentence, for example:

“Generate a high-resolution image of vivid red Aomori apples in a wooden crate, placed in front of green mountains and a blue sky in northern Japan, in a bright, realistic photographic style.”

The server includes additional parameters (image size, aspect ratio, style tags) and encapsulates them with the prompt sentence.

Output: a completed image-generation prompt sentence and parameter set.

### Step 9

The server requests a visual representation image from the image-generation generative AI model.

Input: the image-generation prompt sentence and parameter set created in Step 8.

The server sends the prompt and parameters to an image-generation service via network, instructing the service to perform a conditional image synthesis process. Internally, a diffusion or transformer-based model converts the textual embedding into successive image refinements. The server receives the generated image as binary data or as a network-accessible URL.

Output: a generated image file or reference URL representing the target article.

### Step 10

The server stores and indexes the generated image.

Input: the generated image file or reference URL from Step 9.

The server stores the image data in a storage subsystem (for example, an object store or file system) and records its location, dimensions, and format. The server writes a record to the image table in the database, associating the image reference with the article identifier and the corresponding version of appeal text.

Output: a stored image record that can be retrieved and combined with text for electronic material.

### Step 11

The server assembles initial electronic material from the appeal text and generated image.

Input: the appeal text record and the image record linked to the article.

The server loads a predefined layout template for electronic material (for example, HTML or PDF template), injects the title, main appeal text, and image reference into placeholder positions, and computes layout properties such as font sizes and positioning. The server produces an electronic document ready for delivery to the terminal.

Output: an initial electronic material object that combines text and image.

### Step 12

The terminal requests and displays the initial electronic material.

Input: a user action, such as selecting the article on the terminal's user interface, and an article identifier sent to the server.

The terminal sends a request for the corresponding material. The server returns the assembled electronic document, and the terminal parses and renders it on the display unit, arranging text blocks and the image within the visible area. The terminal adapts layout to the device resolution (for example, reflowing text for a small screen).

Output: a visual presentation of the electronic material to the user on the terminal display.

### Step 13

The terminal captures expression information of the user during viewing.

Input: the current view state where the electronic material is being displayed.

The terminal activates the camera and microphone (with user consent) and periodically captures facial image frames and short audio segments. The terminal timestamps each capture and associates it with the current article/session. The terminal may optionally downscale images or compress audio to reduce bandwidth.

Output: a stream or batch of expression information packets containing facial and audio data.

### Step 14

The terminal or the server transmits the expression information for emotion estimation.

Input: the expression information packets from Step 13.

The terminal packages multiple frames and audio samples into a request and sends them to the server over a secure channel. The server receives the packets and places them in a processing queue, or, in an alternative embodiment, the terminal processes them locally. In either case, the expression information is prepared as input for the emotion estimation model (for example, normalized image sizes and audio sampling rates).

Output: preprocessed expression information ready for feature extraction and emotion estimation.

### Step 15

The server estimates the user's emotion state based on expression information.

Input: the preprocessed expression information, including facial images and audio features.

The server runs a feature extraction pipeline: for each image, the server applies face detection and then a convolutional neural network to obtain facial feature vectors; for each audio segment, the server computes spectral features and feeds them into a neural network for acoustic emotion cues.

The server concatenates or otherwise fuses these feature vectors and inputs them to an emotion estimation neural network trained with labeled emotion data. The network outputs probabilities for multiple emotion categories (for example, joy, excitement, anxiety). The server selects the category with highest probability or above a threshold as the current emotion state.

Output: a structured emotion state object containing emotion labels and confidence scores.

### Step 16

The server maps the emotion state to a content adaptation strategy.

Input: the emotion state object and existing article/appeal text information.

The server uses a rule table or decision logic that associates each emotion category with a strategy (for example, “excitement->amplify enthusiasm,” “anxiety->provide reassurance,” curiosity->add background details”). The server determines whether new content should be appended, emphasized, or substituted and whether image mood should be adjusted.

Output: a content adaptation directive specifying how to adjust prompt sentences and generated material.

### Step 17

The server constructs an emotion-adaptive prompt sentence for the language-generation generative AI model.

Input: the content adaptation directive, the article information, and the existing appeal text.

The server inserts the emotion state and strategy into a new prompt template. For example, for excitement, the server may construct:

“The customer is feeling strong excitement about this product. Based on the following product information and the existing appeal text, please generate an additional marketing sentence that amplifies this excitement and encourages purchase, while remaining accurate and trustworthy. [Product information and existing appeal text here.]” For anxiety, the server may construct:

“The customer is feeling anxiety about the safety and reliability of this product. Based on the following product information, please generate a reassuring paragraph that clearly explains safety measures, quality control procedures, and certifications, in a calm and trustworthy tone.”

The server concatenates the instruction and data portions into a final prompt sentence and assigns appropriate generation parameters (for example, lower temperature for reassurance, higher for enthusiasm).

Output: an emotion-adaptive prompt sentence and parameter set for text generation.

### Step 18

The server generates emotion-adaptive appeal text using the generative AI model.

Input: the emotion-adaptive prompt sentence and parameter set from Step 17.

The server sends this prompt to the language-generation generative AI model, receives the generated text tokens, decodes and cleans the text, and appends it to or merges it with the existing appeal text according to the content adaptation directive (for example, adding a “Why this excites our customers” section or a “Safety and quality” section).

Output: an updated appeal text record that includes emotion-adaptive content.

### Step 19

The server optionally constructs an emotion-adaptive prompt sentence for the image-generation generative AI model.

Input: the content adaptation directive, the article information, and any new emotion-adaptive text.

The server modifies the earlier image prompt or constructs a new one, reflecting the emotion state.

For example, for excitement, the server may create:

“Generate an image of the product with energetic lighting, vivid colors, and a dynamic composition that emphasizes excitement and joy.”

For anxiety, the server may create:

“Generate an image of the product in a clean, calm environment with soft lighting and visible quality and safety labels to reassure the customer.”

The server bundles this prompt with image generation parameters.

Output: an emotion-adaptive image-generation prompt sentence and parameter set.

### Step 20

The server generates and stores an emotion-adaptive image.

Input: the emotion-adaptive image prompt and parameter set from Step 19.

The server calls the image-generation generative AI model, receives the newly synthesized image, and stores it in the storage subsystem; the server then updates or adds a record in the image table linked to the article and the emotion state.

Output: an updated or additional image record representing the emotion-adaptive visual content.

### Step 21

The server reconstructs and updates the electronic material with emotion-adaptive content.

Input: the updated appeal text record and the updated or additional image record.

The server reloads the layout template, injects the revised text and images according to their designated regions, and may use conditional logic to show emotion-specific sections. The server generates an updated electronic document and increments a version identifier or timestamp.

Output: a revised electronic material object reflecting the current emotion-adaptive content.

### Step 22

The terminal retrieves and re-renders the updated electronic material in real time.

Input: a server notification or periodic polling result indicating that a new version of the material is available.

The terminal requests the updated material, receives the revised document, and re-renders the content on the display, replacing or augmenting the previous text and images. The user thus sees changes corresponding to their current emotion state without manually refreshing the view.

Output: an updated visual presentation that is synchronized with the latest emotion state.

### Step 23

The server optionally generates static electronic material as a snapshot.

Input: a trigger condition, such as the end of a session or a user request to export the material, and the current combination of appeal text and images.

The server selects the final text and image configuration, renders a static document (for example, PDF or static HTML), stores it in persistent storage, and creates a persistent reference identifier (such as a URL). The server transmits this identifier to the terminal.

Output: a static electronic material file and a persistent reference that can be stored, printed, or shared independent of further emotion-based updates.

### Step 24

The user and the terminal use the static electronic material for external purposes.

Input: the persistent reference identifier received from the server.

The terminal resolves the identifier to access the static material, displays it to the user, and offers options to download, print, or share the file to an external apparatus (for example, another device or a printing system). The user can then perform offline review or distribution.

Output: external use of a stable representation of the generated material, decoupled from the real-time adaptation loop.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

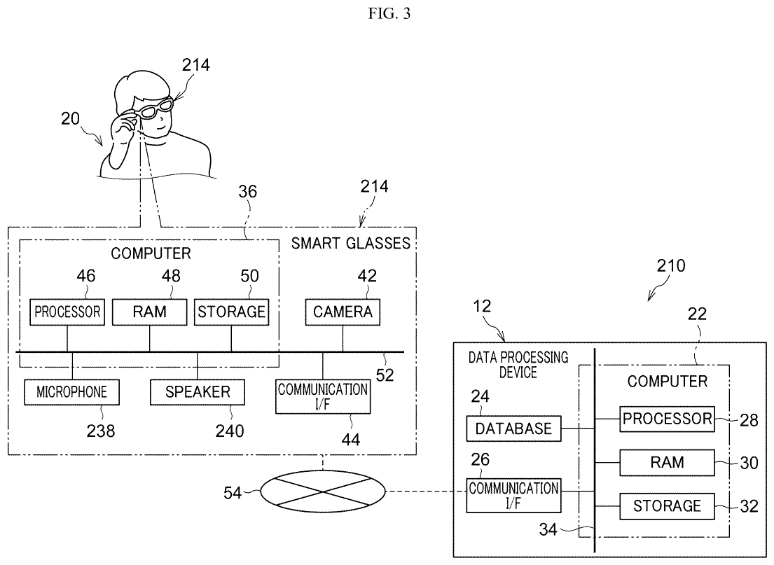

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

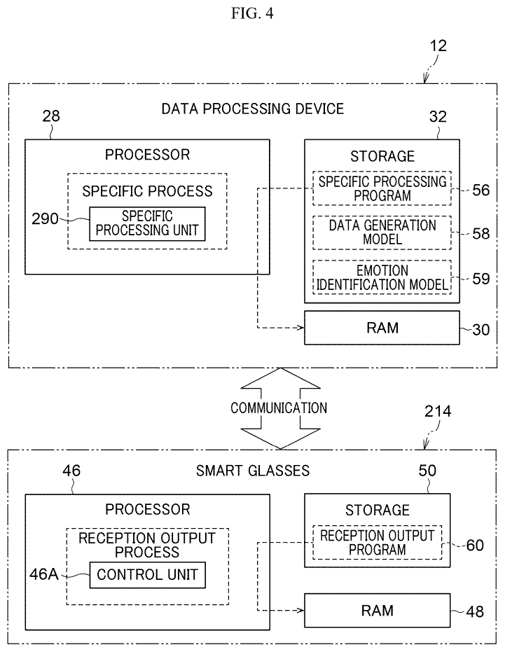

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

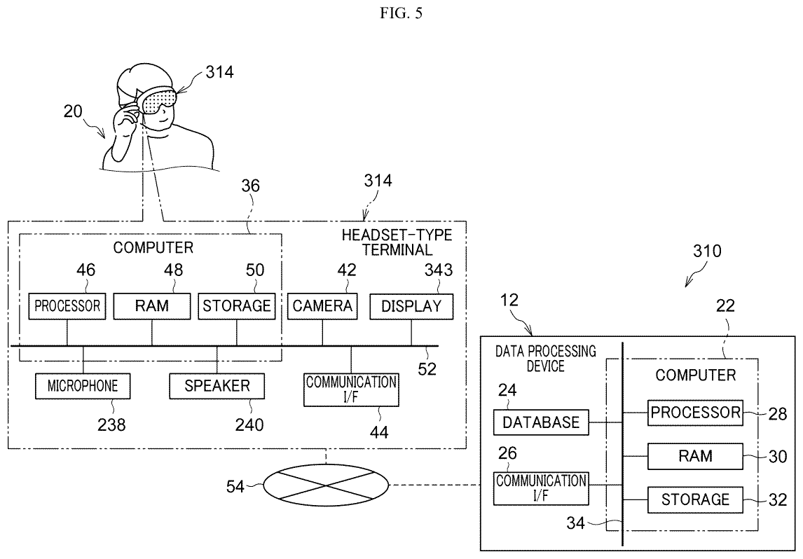

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

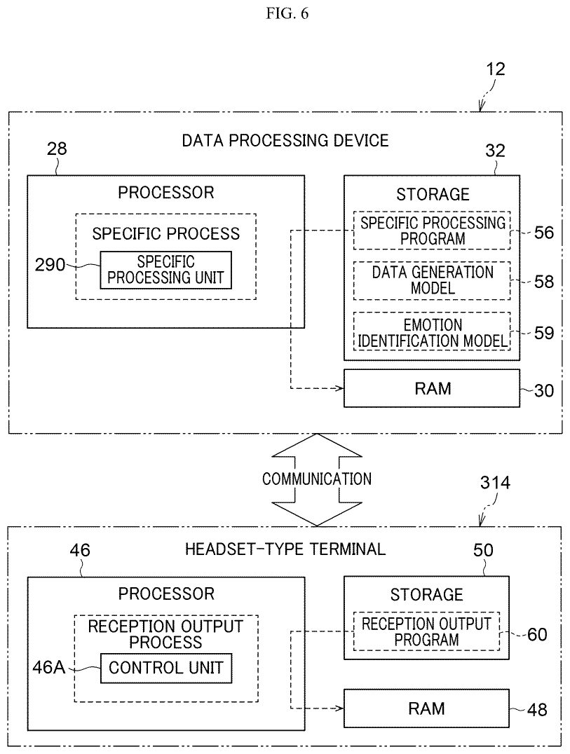

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

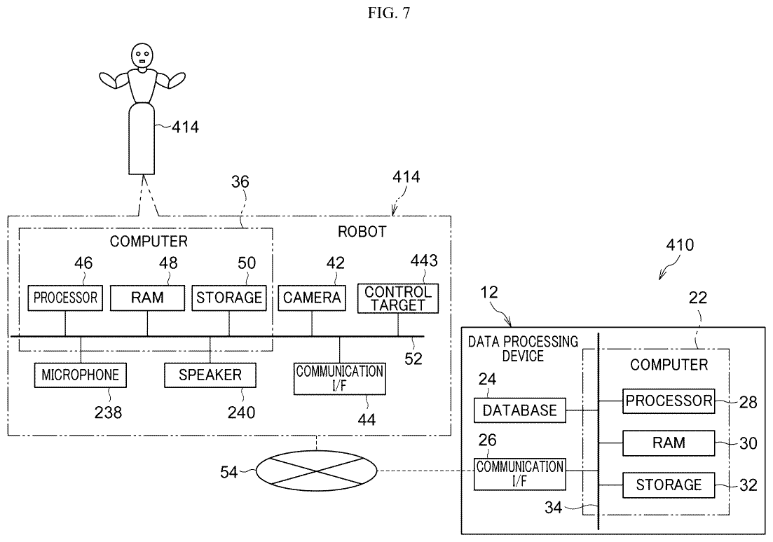

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

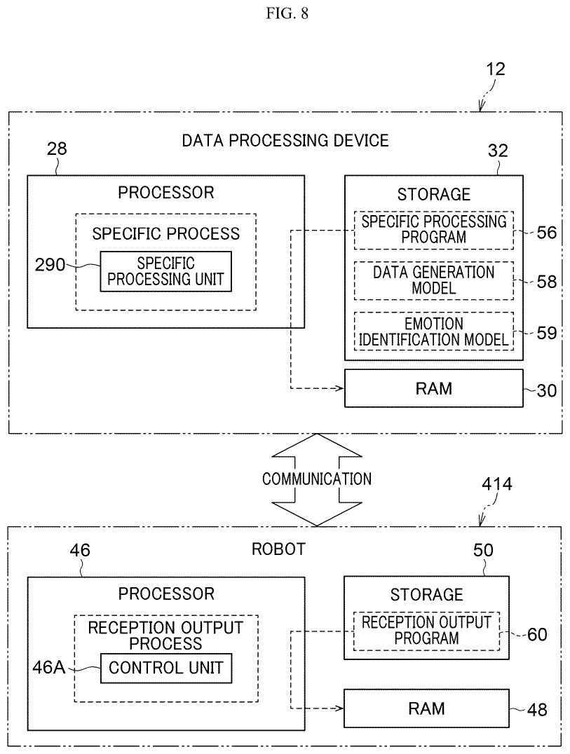

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

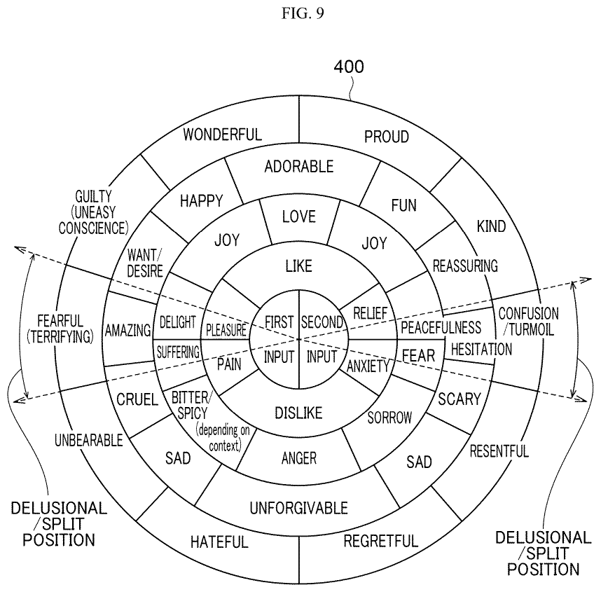

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

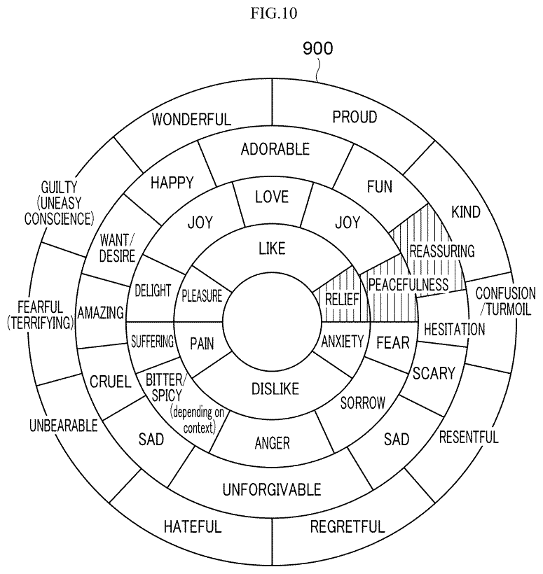

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, by using an information processing apparatus, attribute information, manufacturing process information, and history information regarding a target article in an interactive question-and-answer format, and to store the acquired information as structured data in a storage device,
read, based on the structured data stored in the storage device and predefined text-generation conditions, a template of a generation instruction sentence, automatically insert the structured data into predetermined positions in the template, thereby generating a prompt sentence for instructing a generative AI model to generate appeal text, and transmit the prompt sentence to a natural language processing apparatus so that the natural language processing apparatus generates appeal text data,
read, based on the structured data stored in the storage device and predefined image-generation conditions, a template of a generation instruction sentence, extract or convert from the structured data a description indicating visual features, automatically insert the description into predetermined positions in the template, thereby generating a prompt sentence for instructing a generative AI model to generate image data representing visual features of the target article, and transmit the prompt sentence to an image generation apparatus so that the image generation apparatus generates the image data,
automatically place the appeal text data and the image data into template data for layout data generation, thereby generating promotional material data in an electronic document format or a screen display format, and
output identification information and acquisition information of the generated promotional material data, and, in response to an acquisition request from an external terminal, enable transmission of the promotional material data.

### Supplementary 2

The system according to supplementary 1,
wherein the processor is configured to, when a modification request for the promotional material data is input from the external terminal, update, based on conditions included in the modification request, the prompt sentence used for generation of the appeal text data and/or the prompt sentence used for generation of the image data, retransmit the updated prompt sentence to the generative AI model to regenerate the appeal text data and/or the image data, and automatically reconfigure the promotional material data based on the regenerated appeal text data and/or the regenerated image data.

### Supplementary 3

The system according to supplementary 1,
wherein the processor is configured to cause the information processing apparatus to sequentially display information input screens related to the target article for each pair of a question and an answer, to successively acquire answer data from a user and thereby form the structured data, and to commonly use the structured data for generation of the prompt sentence and for generation of the promotional material data.

### Application Example 1

### Supplementary 1

A system comprising a processor,
wherein the processor is configured to
receive image data acquired from an imaging device that captures an image of a target article arranged in a real space, apply image recognition processing to the image data to identify the target article, and generate identification information of the target article,
acquire, on the basis of the identification information of the target article, attribute information, production information, and history information related to the target article that are stored in a storage device connected via a communication network,
generate a prompt sentence including the acquired information related to the target article, input the prompt sentence to a generative AI model, and cause the generative AI model to generate, in a natural language, an appeal sentence that explains characteristics and history of the target article and stimulates purchase motivation,
generate a prompt sentence including the acquired information related to the target article, input the prompt sentence to an image generation device, and cause the image generation device to generate an image that represents visual features of the target article,
integrate the generated appeal sentence and the generated image to construct display data, and transmit the display data to a portable display terminal and cause the portable display terminal to present, in real time, the appeal sentence and the image in superposition with a real scene of the target article by a visual presentation device of the portable display terminal.

### Supplementary 2

The system according to supplementary 1,
wherein the processor is configured to
obtain, on the basis of a voice input or an operation input acquired from the portable display terminal, an inquiry sentence related to the target article, generate a prompt sentence including the inquiry sentence and the information related to the target article, input the prompt sentence to the generative AI model, cause the generative AI model to generate a response sentence in a one-question-one-answer format, and transmit the response sentence to the portable display terminal for presentation.

### Supplementary 3

wherein the processor is configured to
receive, from the portable display terminal, the identification information of the target article that has been generated by the portable display terminal on the basis of a result of detection and identification of the target article performed on the image data from the imaging device.

### Example 2

### Supplementary 1

A system comprising a processor,
wherein the processor is configured to
acquire, via a communication network, attribute information, production environment information, provider background information, and usage pattern information regarding a target article, the information being input from a user terminal in a sequential one-question-and-one-answer format,
and store the acquired information as structured data in a storage area of a storage device, and generate, using the structured data stored in the storage area, a prompt sentence as a character string by inserting the structured data into a predetermined text-generation template, the prompt sentence instructing generation of appeal text that emphasizes characteristics and background of the target article, and control input of the prompt sentence to a generative artificial intelligence model for natural language generation so as to cause generation and acquisition of text data including the appeal text by the generative artificial intelligence model, and
generate, using at least one of the structured data stored in the storage area and the generated text data, an image-generation prompt sentence as a character string that visually represents the target article and an environment related to the target article, and control input of the image-generation prompt sentence to a generative artificial intelligence model for image generation so as to cause generation and acquisition of image data including an image by the generative artificial intelligence model, and
integrate the text data and the image data based on layout information, and automatically generate marketing material data in at least one of an electronic document format and an image format, and provide the marketing material data to the user terminal in a downloadable format, and, in response to an additional instruction from the user terminal, modify at least one of the prompt sentences and perform regeneration of the text data and the image data by the generative artificial intelligence models.

### Supplementary 2

wherein the processor is configured to
assign question identification information and order information to each answer received in the one-question-and-one-answer format from the user terminal, store the answers as the structured data in the storage area, and reconstruct the structured data based on the order information to generate an information profile for each target article.

### Supplementary 3

The system according to supplementary 1,
wherein the processor is configured to
after generation of the marketing material data, add at least one of emphasis-change information, expression-style-change information, and visual-expression-change information, which is received from the user terminal, to the information profile, and modify at least one of the text-generation template and the image-generation prompt sentence based on the added information so as to enable regeneration of the appeal text and the image by the generative artificial intelligence models.

### Application Example 2

### Supplementary 1

A system comprising a processor,
wherein the processor is configured to
use an information processing apparatus to electronically collect information regarding attributes, processes, and origins of a target article and store the information in a storage unit,
generate a prompt sentence including an instruction text for a language-generation generative artificial intelligence model based on the information stored in the storage unit, and cause a natural language processing apparatus using the generative artificial intelligence model to generate appeal text information,
generate a prompt sentence including an instruction text for an image-generation generative artificial intelligence model based on the information stored in the storage unit and the appeal text information, and cause an image generation apparatus using the generative artificial intelligence model to generate visual representation image information,
acquire expression information of a user from a display information processing apparatus and use an emotion estimation model, which estimates an emotion state based on the expression information, to specify an emotion state of the user,
regenerate, based on the emotion state and the information stored in the storage unit, a prompt sentence that explicitly includes the emotion state for input to the generative artificial intelligence model, and cause the generative artificial intelligence model to additionally generate emotion-adaptive appeal text information and/or emotion-adaptive visual representation image information, integrate the appeal text information, the visual representation image information, and the emotion-adaptive appeal text information and/or the emotion-adaptive visual representation image information to generate electronic material for visual output, and
provide the electronic material to the display information processing apparatus via a communication network and repeatedly update generation of the prompt sentence and generation of the electronic material in real time according to changes in the emotion state so that the electronic material is updatable in real time.

### Supplementary 2

The system according to supplementary 1,
wherein the processor is configured to cause the display information processing apparatus to acquire facial expression information and voice information of the user while the electronic material is being displayed, to transmit the facial expression information and the voice information as the expression information to the system, to specify the emotion state based on the expression information, and to control contents of the prompt sentence input to the generative artificial intelligence model according to the emotion state so as to dynamically change the appeal text information and the visual representation image information.

### Supplementary 3

The system according to supplementary 1,
wherein the processor is configured to generate, separately from updating of the electronic material, static electronic material in which the appeal text information and the visual representation image information are fixed at a predetermined time, to associate persistent reference information with the static electronic material, to transmit the persistent reference information to the display information processing apparatus, and to enable the display information processing apparatus to store or share the static electronic material with an external apparatus based on the persistent reference information.

What is claimed is:

1. A system comprising:
circuitry configured to:
acquire, via a communication interface coupled to a packet-switched network, attribute data, process data, and origin data regarding a target article in an interactive question-and-answer format from a terminal device, convert response data into structured data, and store the structured data in a storage device;
read the structured data and predefined text-generation condition data from the storage device, populate a text-generation template with the structured data to generate a first prompt data structure instructing a generative neural network model for natural language generation, and transmit the first prompt data structure to a natural language processing apparatus to cause generation of text data;
read the structured data and predefined image-generation condition data from the storage device, extract description data indicative of visual features from the structured data, populate an image-generation template with the description data to generate a second prompt data structure instructing a generative neural network model for image generation, and transmit the second prompt data structure to an image generation apparatus to cause generation of image data;
place the text data and the image data into layout template data to generate integrated material data in at least one of an electronic document format and a display format; and
output identification data and acquisition data of the integrated material data, and, in response to a modification request from the terminal device, update at least one of the first prompt data structure and the second prompt data structure based on conditions included in the modification request, retransmit the updated prompt data structure to the corresponding generative neural network model to regenerate the text data or the image data, and reconfigure the integrated material data based on the regenerated data.

2. The system according to claim 1,
wherein the circuitry causes the terminal device to sequentially display information input screens for each question-and-answer pair, successively acquires answer data from a user, and forms the structured data from the successively acquired answer data, the structured data being commonly used for generation of both the first prompt data structure and the second prompt data structure.

3. The system according to claim 2,
wherein the circuitry assigns question identification data and order data to each answer received from the terminal device, stores the answers as the structured data in the storage device, and reconstructs the structured data based on the order data to generate an information profile for the target article.

4. The system according to claim 3,
wherein the circuitry generates the first prompt data structure by inserting the structured data of the information profile into a predetermined text-generation template, the first prompt data structure instructing generation of descriptive text that emphasizes characteristics and background of the target article.

5. The system according to claim 4,
wherein the circuitry generates the second prompt data structure by using at least one of the structured data of the information profile and the generated text data, the second prompt data structure instructing generation of image data visually representing the target article and an environment associated with the target article.

6. The system according to claim 5,
wherein the circuitry, after generation of the integrated material data, receives from the terminal device at least one of emphasis-change data, expression-style-change data, and visual-expression-change data, adds the received data to the information profile, and modifies at least one of the text-generation template and the second prompt data structure based on the added data to regenerate the text data and the image data.

7. The system according to claim 1,
wherein the circuitry is further configured to receive image data acquired from an imaging device that captures an image of the target article, apply image recognition processing to the image data to identify the target article and generate identification data, and acquire, based on the identification data, the attribute data, process data, and origin data from the storage device.

8. The system according to claim 7,
wherein the circuitry transmits the integrated material data comprising the text data and the image data to a portable display terminal, and causes the portable display terminal to present the text data and the image data in superposition with a real scene of the target article via a visual presentation device of the portable display terminal.

9. The system according to claim 8,
wherein the circuitry is further configured to obtain, based on a voice input or an operation input acquired from the portable display terminal, a query sentence related to the target article, generate a query prompt data structure comprising the query sentence and the attribute data, transmit the query prompt data structure to the generative neural network model for natural language generation, and transmit a response sentence to the portable display terminal for presentation.

10. The system according to claim 1,
wherein the circuitry is further configured to acquire expression data of a user from a display terminal, apply an emotion estimation model to the expression data to determine an emotion state of the user, regenerate at least one updated prompt data structure that explicitly includes the emotion state as an input condition, and cause the generative neural network model to generate emotion-adaptive text data or emotion-adaptive image data in response to the updated prompt data structure.

11. The system according to claim 10,
wherein the circuitry integrates the text data, the image data, and at least one of the emotion-adaptive text data and the emotion-adaptive image data into the integrated material data, provides the integrated material data to the display terminal, and repeatedly updates generation of the prompt data structures and the integrated material data according to changes in the emotion state.

12. The system according to claim 11,
wherein the circuitry causes the display terminal to acquire facial expression data and voice data of the user while the integrated material data is being displayed, receive the facial expression data and the voice data as expression data, determine the emotion state based on the expression data, and control contents of the prompt data structure input to the generative neural network model according to the emotion state to dynamically change the text data and the image data.

13. The system according to claim 11,
wherein the circuitry generates, separately from real-time updating of the integrated material data, static material data in which the text data and the image data are fixed at a predetermined time, associates persistent reference data with the static material data, and transmits the persistent reference data to the display terminal to enable storage or sharing of the static material data with an external apparatus.

14. The system according to claim 1,
wherein the text-generation template comprises placeholder fields corresponding to attribute data, process data, and origin data, and the circuitry populates each placeholder field with a corresponding element of the structured data to generate the first prompt data structure.

15. The system according to claim 1,
wherein the image-generation template comprises placeholder fields for visual feature descriptions, and the extracting of description data comprises selecting, from the structured data, fields that describe physical appearance, color, texture, or dimensional characteristics of the target article.

16. The system according to claim 1,
wherein the layout template data comprises predefined regions for text placement and image placement, and the circuitry automatically maps the text data to text regions and the image data to image regions based on content type metadata associated with each data element.

17. The system according to claim 1,
wherein the modification request comprises at least one of a text modification parameter and an image modification parameter, and the circuitry selectively updates only the prompt data structure corresponding to the modified parameter to avoid regeneration of unmodified content.

18. A system comprising:
circuitry configured to:
acquire attribute data, process data, and origin data regarding a target article from a terminal device via a communication interface, and store the data as structured data in a storage device;
populate a text-generation template with the structured data to generate a first prompt data structure, and transmit the first prompt data structure to a generative neural network model for natural language generation to obtain text data;
populate an image-generation template with visual feature description data extracted from the structured data to generate a second prompt data structure, and transmit the second prompt data structure to a generative neural network model for image generation to obtain image data;
place the text data and the image data into layout template data to generate integrated material data;
output the integrated material data to the terminal device; and
in response to a modification request, update at least one of the first prompt data structure and the second prompt data structure and regenerate the corresponding text data or image data.

19. The system according to claim 18,
wherein the circuitry is further configured to acquire expression data of a user, determine an emotion state by an emotion estimation model, and regenerate at least one prompt data structure including the emotion state to obtain emotion-adaptive text data or image data.

20. A method comprising:
acquiring, by circuitry via a communication interface coupled to a packet-switched network, attribute data, process data, and origin data regarding a target article from a terminal device, and storing the data as structured data in a storage device;
populating a text-generation template with the structured data to generate a first prompt data structure, and transmitting the first prompt data structure to a generative neural network model for natural language generation to obtain text data;
populating an image-generation template with visual feature description data extracted from the structured data to generate a second prompt data structure, and transmitting the second prompt data structure to a generative neural network model for image generation to obtain image data;
placing the text data and the image data into layout template data to generate integrated material data;
outputting identification data and acquisition data of the integrated material data to the terminal device; and
in response to a modification request from the terminal device, updating at least one of the first prompt data structure and the second prompt data structure, regenerating the corresponding text data or image data, and reconfiguring the integrated material data.
